(19) United States
(12) Patent Application Publication
(10) Pub. No.: US 2012/0060100 A1
(43) Pub. Date: Mar. 8, 2012

(54) System and method for transferring media content

(75) Inventors: Greg Sherwood, Inverness, IL (US); Osama Al-Shaykh, San Diego, CA (US); Mark Smith, San Diego, CA (US); Ralph Neff, San Diego, CA (US); Joel Espelien, San Diego, CA (US)

(73) Assignee: PacketVideo Corporation

(21) Appl. No.: 12/927,007

(22) Filed: Nov. 4, 2010

Related U.S. Application Data
(60) Provisional application No. 61/402,763, filed on Sep. 3, 2010.

(51) Int. Cl. G06F 15/16; G06F 3/01

(52) U.S. Cl. 715/748

(57) ABSTRACT

A system and a method transfer media content. An application may identify rendering devices in a network and/or may register with an events framework for media-related actions. The application may receive information for a media-related action which specifies media content and an action. The application may identify one or more of the rendering devices as capable of rendering the media content and may use a communication to direct the identified rendering device to render the media content. The identified rendering device may render the media content in response to the communication from the application.

This application claims the benefit of U.S. Provisional Application Ser. No. 61/402,763, filed Sep. 3, 2010.

### BACKGROUND OF THE INVENTION

The present invention generally relates to a system and a method for transferring media content. More specifically, the present invention relates to a media handler application for a general purpose computing device.

General purpose computing devices are increasingly used to browse, discover, retrieve, consume, play, view, create, edit, organize and/or use media content. General purpose computing devices are computing devices capable of running software which may be pre-loaded on the device or may be obtained and installed by a user of the device. Examples of these devices are desktop personal computers, laptop personal computers, netbook computers, personal digital assistants (PDAs), mobile telephones, gaming consoles, portable gaming devices and/or the like. General purpose computing devices typically have an operating system (OS) which has built-in support for media functions, such as, for example, decoding and/or displaying visual content and/or audio content. General purpose computing devices are typically capable of connecting to a communication network, such as, for example, a local area network and/or a wide area network.

On these devices, multiple software applications may use media content using the media functions provided by the OS. For example, a web browser application may allow a user of the general purpose computing device to browse, retrieve and consume media content associated with web pages. As another example, a media player application may allow the user to play files and/or streams which contain media content such as audio content and/or video content. As yet another example, a photo viewer application may allow the user to browse, discover, view, edit and/or consume image files. As still another example, a camera application may allow the user to create media content files containing video and/or image content. As another example, a media management application may allow the user to organize and/or edit media content objects and/or to create derivative works based on those objects.

Many sources may provide the software applications which use media content. Some of the software applications may be pre-loaded and shipped with the computing device, and other software applications may be obtained and installed after the computing device is obtained by the user. As illustrated by the above examples, the various software applications may perform very different media-related tasks. However, the OS on the computing device may provide a framework under which the various media-related software applications may make media content available to other applications, services and handlers which may be available on the computing device. The framework is typically provided by an events framework under which a class of events may be defined for transferring media content from one application to another for pre-defined actions, such as, for example, “EDIT,” “PRINT,” “SHARE” and/or the like.

Hereafter, “media source application” refers to any media-capable application which uses an events framework to make media content available to other applications, services and/or handlers. “Media handler application” refers to any application, service and/or handler which registers with an events framework to receive media-related actions and/or events.

For example, any of the previously mentioned media-capable applications may function as a media source application. “SHARE” may be an action based on the events framework, and the media source application may allow the user to “SHARE” the various media content objects available within the media source application. Thus, the media source application may query the events framework provided by the OS to obtain a list of media handler applications which have registered with the OS and/or the events framework as a valid destination with which to “SHARE” media. As part of the query, the media source application may specify the type of media which is currently in context, and the events framework may narrow the list of media handler applications to include only the media handler applications which are valid destinations for the specified type of media. A type of media may be specified as a general type, such as, for example, audio, video or image. Further, a type of media may be specified by using more specific typing language, such as, for example, specifying one or more parameters, such as file format, media codec, profile, level and/or MIME type. One skilled in the art will recognize other media properties which may be used to specify the type of media currently in context 20, in a media source application.

In response to the query, the events framework may provide a list of media handler applications to which the relevant media content may be transferred, sent and/or shared. Then, the media-capable software application may provide “SHARE” options to the user of the media-capable software application. For example, the media-capable software application may inform the user that the media content may be sent in an outgoing email message; may be referenced in an outgoing Short Message Service message (SMS); may be posted to a social networking site, such as, for example, Facebook or Twitter; and/or the like. Each of these options may correspond to a media handler application which is registered with the OS as a valid media destination for “SHARE” actions.

If the user of the media source application invokes one of the “SHARE” options, the media source application may communicate the media content or a reference to the media content to the media handler application corresponding to the “SHARE” option selected by the user. The communication may use the events framework or may use a different communication path based on information obtained from the events framework. For example, the media source application may communicate directly with a media handler application which was previously identified by the events framework as a valid media destination for the selected “SHARE” option.

Based on the communication, the media handler application which receives the communication may take steps to transfer the media content over an appropriate channel. For example, a “share-to-email” handler may use a default email program to create a new outgoing email message initialized to contain a copy of a URL which references the media content. Then, the user may complete and send the email message to one or more recipients selected by the user.

An advantage of the above-described events framework is that a single media handler application may process actions which may originate from multiple media source applications, and the various media source applications may not have been known at the time the media handler application was created. In this way, the events framework allows the OS to arrange suitable introductions between the media source applications which may originate a “SHARE” action and the media handler applications which may receive and process the “SHARE” action.

However, the events framework is typically limited in that only certain actions, such as, for example, “SHARE,” “PRINT,” and “EDIT,” may be defined by the events framework. A specific events framework may be extensible in that the events framework may allow new and/or arbitrary actions to be defined, and the new and/or arbitrary actions are generally not known to or supported by the various media source applications from which the media handler application may receive media. Further, the registration information provided by the media handler application at the time the media handler application registered with the events framework and/or the OS may be limited to the types of actions and/or the media content types which are supported by the media handler application. Such limitations may be strict in that the events framework may not allow other information to be provided at registration time, and/or the limitations may be practical limitations because the new and/or arbitrarily defined information provided at registration time is unlikely to be understood by and/or supported by the various media source applications.

Therefore, media actions which do not correspond to a pre-defined, well-known media action may not be suitable for execution using the events framework provided by the OS of a general purpose computing device. Further, a media action may be dynamic in nature and/or may require the user to have current information and/or status about the availability and/or nature of the media action. Such a media action may not be suitable for communication using the events framework because dynamic information and/or status may not be provided to the user within the media source application. The media source application may support the media action but may not process the information and/or the status provided by a specific media handler application capable of processing the media action.

A dynamic media action is rendering of media content to an external rendering device, namely a rendering device which is external to the general purpose computing device executing the media source application. Rendering to an external rendering device is dynamic because the availability of one or more external rendering devices is required. Further, rendering to an external rendering device is dynamic because the available rendering options may depend on the capabilities of the one or more available external rendering devices. Therefore, projecting information about the availability of, the capabilities of and/or the state of the external rendering devices into the media source application which may provide media content to an media handler application for rendering on an external rendering device may be advantageous. However, existing events frameworks do not provide for the explicit communication and use of such dynamic information.

### SUMMARY OF THE INVENTION

The present invention generally relates to a system and a method for transferring media content. More specifically, an application may identify rendering devices in a network and/or may register with an events framework for media-related actions. The application may receive information for a media-related action which specifies media content and an action. The application may identify one or more of the rendering devices as capable of rendering the media content and may use a communication to direct the identified rendering device to render the media content. The identified rendering device may render the media content in response to the communication from the application.

To this end, in an embodiment of the present invention, a method for transferring media content using a media handler application executed by a general purpose computing device connected to a network is provided. The method has the steps of identifying one or more rendering devices in the network wherein the media handler application identifies the one or more rendering devices in the network; registering with an events framework wherein the media handler application registers for media actions with the events framework; receiving information on the media handler application wherein the information specifies a first media action of the media actions and further wherein the information specifies identified media content; identifying a target rendering device of the one or more rendering devices in the network wherein the target rendering device is capable of rendering the identified media content and further wherein the media handler application identifies the target rendering device; transmitting a communication from the media handler application to the target rendering device wherein the communication instructs the target rendering device to render the identified media content; and rendering the identified media content on the target rendering device in response to the target rendering device receiving the communication.

In an embodiment, the method has the steps of displaying options in a user interface of a media source application executed by the general purpose computing device wherein the options are displayed after the media handler application registers with the events framework and further wherein the options are related to media content available in the media source application wherein one of the options corresponds to the media handler application and further wherein the media source application is a different application than the media handler application; accepting user input on the general purpose computing device which selects the one of the options corresponding to the media handler application; and generating the information which specifies the first media action and the identified media content wherein the media source application generates the information in response to the user input selecting the one of the options corresponding to the media handler application.

In an embodiment, the one or more rendering devices in the network are UPnP AV-compliant rendering devices.

In an embodiment, the media handler application identifies the target rendering device based on capabilities of the target rendering device.

In an embodiment, the media handler application identifies the target rendering device based on one or more preferred rendering devices specified by a user of the media handler application before the media handler application received the information which specifies the first media action and the identified media content.

In an embodiment, the method has the steps of displaying a list of rendering devices capable of rendering the identified media content wherein the media handler application displays the list after receiving the information which specifies the first media action and the identified media content; and accepting user input on the general computing device which selects the target rendering device from the list wherein the communication is transmitted to the target rendering device in response to the user input.

In an embodiment, the media handler application registers with the events framework in response to detection of one of the one or more rendering devices in the network.

In an embodiment, the media handler application registers with the events framework in response to the general purpose computing device connecting to the network.

In another embodiment of the present invention, a method for transferring media content using a media handler application executed by a general purpose computing device connected to a network is provided. The method has the steps of identifying one or more rendering devices in the network wherein the media handler application identifies the one or more rendering devices in the network; registering with an events framework wherein the media handler application registers for media actions with the events framework and further wherein the media handler application provides registration information based on media capabilities of the one or more rendering devices; generating information which specifies a first media action of the media actions wherein the information specifies the media content wherein a media source application executed by the general purpose computing device generates the information and further wherein the media source application is a different application than the media handler application; receiving the information wherein the media handler application receives the information; and transmitting a communication to one of the one or more rendering devices wherein the communication instructs the one of the one or more rendering devices to render the media content and further wherein the media handler application transmits the communication in response to receiving the information which specifies the first media action and the media content.

In an embodiment, the method has the steps of displaying options related to media content available in the media source application wherein the options are displayed by a user interface provided by the media source application and further wherein one or more of the options are based on the registration information; and accepting user input which identifies a selected option of the options wherein the selected option is one of the one or more options based on the registration information and further wherein the media source application generates the information in response to the user input.

In an embodiment, the communication uses a protocol based on the UPnP AV standard.

In an embodiment, the registration information describes an aggregate set of media capabilities for the one or more rendering devices.

In an embodiment, the method has the step of identifying a capable rendering device of the one or more rendering devices wherein the capable rendering device is capable of rendering the media content and further wherein the media handler application identifies the capable rendering device based on the capabilities of the one or more rendering devices.

In an embodiment, the method has the step of modifying the media content for compatibility with the media capabilities of the one of the one or more rendering devices wherein the media handler application modifies the media content.

In an embodiment, the media content is located on a remote server accessible using the Internet and further wherein the communication sent from the media handler application to the one of the one or more rendering devices includes a URL which specifies the location of the media content.

In an embodiment, the media handler application has a server component which provides access to the media content for the one of the one or more rendering devices which receives the communication.

In another embodiment of the present invention, a method for transferring media content using a media handler application executed by a general purpose computing device connected to a network is provided. The method has the steps of identifying one or more rendering devices in the network wherein the media handler application identifies the one or more rendering devices in the network; registering a first handler service with an events framework wherein the media handler application registers the first handler service for media actions with the events framework and further wherein the first handler service corresponds to a first rendering device of the one or more rendering devices and further wherein registration of the first handler service associates the first handler service with media capabilities of the first rendering device; generating first information which specifies first media content wherein a media source application generates the first information based on first user input in the media source application and further wherein the media source application is a different application than the media handler application; receiving the first information wherein the first handler service receives the first information based on the registration of the first handler service with the events framework; and directing the first rendering device to render the first media content in response to the first handler service receiving the first information.

In an embodiment, the method has the step of providing registration information which includes a text string descriptive of the first rendering device wherein the media handler application provides the registration information when registering the first handler service.

In an embodiment, the method has the step of providing registration information which includes a graphic image descriptive of the first rendering device wherein the media handler application provides the registration information when registering the first handler service.

In an embodiment, the method has the steps of displaying options in a user interface provided by the media source application wherein the options relate to the first media content and include a first option associated with the first handler service; accepting second user input wherein the second user input selects the first option; and transmitting the first information wherein the media source application transmits the first information in response to the second user input.

In an embodiment, the method has the step of registering a second handler service with the events framework wherein the second handler service corresponds to a second rendering device and further wherein the media handler application registers the second handler service.

In an embodiment, the method has the step of registering a second handler service with the events framework wherein the second handler service corresponds to a group of rendering devices which includes the first rendering device and a second rendering device and further wherein the media handler application registers the second handler service.

In an embodiment, the method has the step of associating the second handler service with media capabilities common to both the first rendering device and the second rendering device wherein the registration of the second handler service associates the second handler service with the media capabilities.

In an embodiment, the method has the steps of generating second information which specifies second media content wherein the media source application generates the second information based on second user input in the media source application; displaying options in the media source application wherein the options relate to the second media content and further wherein the options include a first option associated with the first handler service and a second option associated with the second handler service; accepting third user input in the media source application wherein the third user input selects the second option; transmitting the second information wherein the media source application transmits the second information in response to the third user input; receiving the second information wherein the second handler service receives the second information based on the registration of the second handler service with the events framework; and directing the first rendering device and the second rendering device to render the second media content in response to the second handler service receiving the second information.

In an embodiment, the method has the steps of defining a profile associated with the first rendering device wherein the profile includes a setting specified by a user of the media handler application and further wherein the setting is associated with a device wherein the setting has a setting identifier and a value and further wherein the first handler service is associated with the profile; and sending instructions to the device wherein the instructions specify the setting identifier and the value.

In an embodiment, the device is the first rendering device.

In an embodiment, the device is one of the one or more rendering devices in the network other than the first rendering device.

In an embodiment, the device is a home automation control device.

In another embodiment of the present invention, a system for transferring media content is provided. The system has a media handler application executed by a general purpose computing device connected to a network wherein the media handler application identifies one or more rendering devices in the network; a first handler service connected to the media handler application wherein the first handler service corresponds to one or more first rendering devices of the one or more rendering devices in the network; a first registration with an events framework wherein the first registration associates the first handler service with media capabilities of the one or more first rendering devices; a second handler service connected to the media handler application wherein the second handler service corresponds to one or more second rendering devices of the one or more rendering devices in the network; a second registration with the events framework wherein the second registration associates the second handler service with media capabilities of the one or more second rendering devices; information received by one of the first handler service and the second handler service wherein the information identifies the media content; and communications transmitted to one or more third rendering devices wherein the communications direct the one or more third rendering devices to render the media content wherein the third rendering devices are the first rendering devices if the information was received by the first handler service wherein the third rendering devices are the second rendering devices if the information was received by the second handler service.

In an embodiment, the one or more first rendering devices associated with the first handler service are specified by a user of the media handler application before the media handler application registers the first handler service with the events framework.

In an embodiment, the media handler application removes the first registration from the events framework in response to unavailability of the one or more first rendering devices.

In an embodiment, the first registration associates the first handler service with media capabilities which are common to all of the one or more first rendering devices.

In an embodiment, the media handler application selects the one or more first rendering devices for association to the first handler service wherein the media handler application selects the one or more first rendering devices from among the one or more rendering devices in the network without user input specifying the one or more first rendering devices.

In an embodiment, the media handler application registers the first handler service with the events framework to produce the first registration and further wherein the media handler application registers the second handler service with the events framework to produce the second registration.

In an embodiment, the media handler application transmits the communications to the one or more third rendering devices.

In an embodiment, at least one of the communications is based on the UPnP AV standard.

In an embodiment, the system has a media source application executed by the general purpose computing device wherein the media content is available in the media source application wherein the media source application is a different application than the media handler application and further wherein the media source application receives information about the first registration and the second registration from the events framework; and a user interface associated with the media source application wherein the user interface displays options which relate to the media content and further wherein the options include a first option associated with the first handler service and a second option associated with the second handler service.

In an embodiment, the system has user input accepted by the user interface wherein the user input selects one of the first option and the second option wherein the media source application transmits the information to the first handler service if the user input selects the first option and further wherein the media source application transmits the information to the second handler service if the user input selects the second option.

It is, therefore, an advantage of the present invention to provide a system and a method for transferring media content.

Another advantage of the present invention is to provide a system and a method for transferring media content which use an events framework to enable a media source application to render media content to an external rendering device.

And, another advantage of the present invention is to provide a system and a method for transferring media content which use an events framework to enable the user of a media source application to view the current availability of one or more external rendering devices.

Yet another advantage of the present invention is to provide a system and a method for transferring media content which use an events framework to enable the user of a media source application to view the current status of one or more external rendering devices.

A further advantage of the present invention is to provide a system and a method for transferring media content which use an events framework to enable the user of a media source application to view a default external rendering device for a relevant media type.

Another advantage of the present invention is to provide a system and a method for transferring media content which use an events framework to enable the user of a media source application to view a list of external rendering devices capable of rendering media content selected in the media source application.

Yet another advantage of the present invention is to provide a system and a method for transferring media content which use an events framework to enable the user of a media source application to view a descriptive name and/or an icon which represent an available external rendering device.

A further advantage of the present invention is to provide a system and a method for transferring media content which registers with an events framework in response to detection of an external rendering device becoming available.

Another advantage of the present invention is to provide a system and a method for transferring media content which de-registers from an events framework in response to detection of an external rendering device becoming unavailable.

Yet another advantage of the present invention is to provide a system and method which register with an events framework in response to detection of a connection to a network becoming available.

Moreover, another advantage of the present invention is to provide a system and a method for transferring media content which use an events framework to enable the user of a media source application to make media content from the media source application available on a media server component so that the media content may be subsequently retrieved from the server component by an external rendering device.

Additional features and advantages of the present invention are described in, and will be apparent from, the detailed description of the presently preferred embodiments and from the drawings.

### BRIEF DESCRIPTION OF THE DRAWINGS

FIGS. 1 and 2 illustrate black box diagrams of systems for transferring media content to a rendering device using an events framework in an embodiment of the present invention.

FIG. 3 illustrates a black box diagram of a media handler application in an embodiment of the present invention.

FIG. 4 illustrates a black box diagram of a system for transferring media content from a media source application to a rendering device by registering multiple handler services with an events framework in an embodiment of the current invention.

FIGS. 5-7 illustrate embodiments of the user interface which may be presented by a media source application.

FIGS. 8-10 illustrate flowcharts for a method for transferring media content to a rendering device using an events framework in embodiments of the present invention.

### DETAILED DESCRIPTION OF THE PREFERRED EMBODIMENTS

The present invention generally relates to a system and a method for transferring media content. More specifically, a media handler application may identify media rendering devices in a network and/or may register with an events framework for media-related actions. A media source application may present options related to media content available in the media source application, and one of the options may correspond to the media handler application. A user may select the option corresponding to the media handler application. The media source application may generate an event based on the events framework, and the event may target the media handler application and/or may specify the media content.

The media handler application may receive information for the selected option. The media handler application may identify one or more of the media rendering devices as capable of rendering the media content and may use one or more communications to direct one or more of the identified media rendering devices to render the media content. An identified media rendering device may render the media content in response to the communication from the media handler application.

Hereafter, “computing device” denotes a general purpose computing device. As defined in the background of the present application, general purpose computing devices are computing devices capable of running software which may be pre-loaded on the device or may be obtained and installed by a user of the device. The computing device may have an operating system (OS) and/or may be capable of executing software. The computing device may be capable of connection to a communication network, such as, for example, a local area network and/or a wide-area network. Examples of a computing device are a desktop personal computer, a laptop personal computer, a netbook computer, a personal digital assistant (PDA), a mobile telephone, a gaming console, a portable gaming device and/or the like.

Hereafter, “media content” denotes audio and/or visual media content which may be rendered on an external media rendering device. Examples of media content are audio content, video content, image content and/or the like. Media content may be in the form of digital content files, such as, for example, video files, audio files, digital photograph files and/or the like. Media content may be delivered and/or may be transferred in various forms, such as, for example, as a downloaded file, a progressively downloaded file, a media stream and/or the like. Media content may be arranged into a presentation, such as, for example, a photo album, a slideshow, an audiovisual presentation, and/or the like. Media content may reside locally on the computing device, may reside in a local storage device in a local area network connected to the computing device and/or may be available from a remote source over a wide area network, such as, for example, the Internet. Media content may be presented by, linked from and/or otherwise associated with a web page.

Hereafter, “events framework” denotes a framework by which applications, services and/or handlers running on a computing device may communicate with each other. The events framework may be provided by the OS. “Media source application” denotes a media-capable application which may provide access to media content using an events framework. For example, a media source application may support a “SHARE” function for media content available in the media source application, and the “SHARE” function may be an action supported by the events framework. The present application uses “SHARE” throughout to explain the invention and to illustrate the various embodiments. However, “SHARE” is merely an example action, and the action name may vary depending on the design of the events framework. For example, the action name and/or the event name may be “SEND,” “SEND_TO,” “TRANSFER,” “VIEW,” “PLAY,” “RENDER” or any other action and/or event name which may be associated with sharing and/or transferring media content from a media source application to a different application, service, handler, media rendering device, website, communication channel and/or other media destination.

Hereafter, “media handler application” denotes an application, service and/or handler which may register with an events framework to handle a media-related action supported by the events framework. For example, the media handler application may register to support, receive, and/or handle SHARE events, and the SHARE events may be actions supported by the events framework. SHARE is an example of an action name for which a media handler application may register in an embodiment of the present invention; however, other action and/or event names may be used as noted previously.

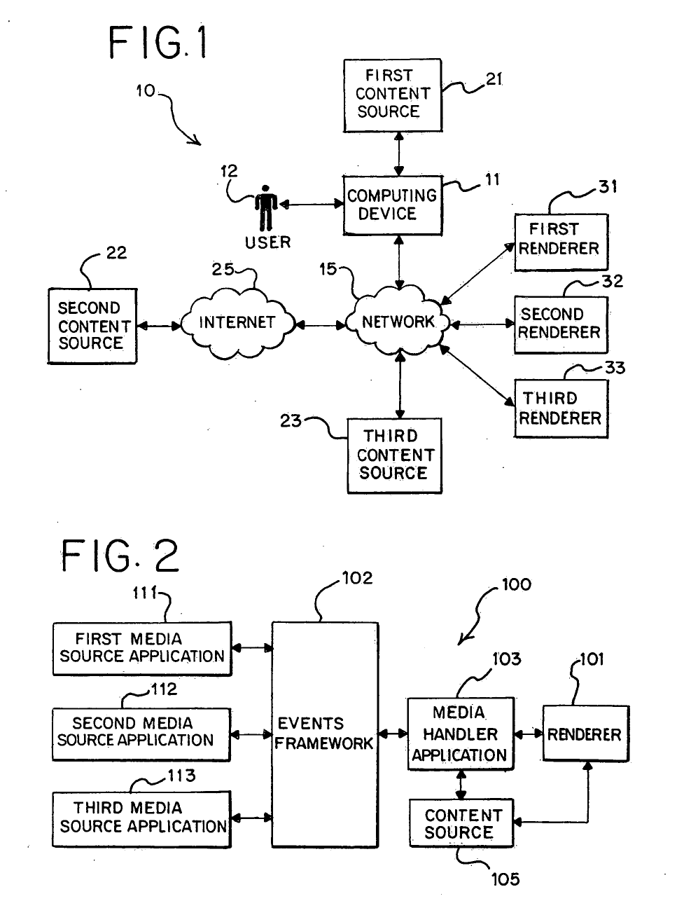

Referring now to the drawings wherein like numerals refer to like parts, FIG. 1 generally illustrates a system 10 for transferring media content available in a media source application on a computing device 11 to a media rendering device using an events framework. FIG. 1 illustrates a typical arrangement of content sources, media rendering devices and networks in which an embodiment of the current invention may operate. As illustrated in FIG. 1, a user 12 of the computing device 11 may access and/or use one or more media source applications on the computing device 11. The media source applications may enable the user 12 to send, transfer and/or share media content available in and/or accessible from the media source applications, and/or such sharing of media content may be based on an events framework provided by the computing device 11. In an embodiment, the user 12 may send, transfer, share, play and/or render the media content to one or more external media rendering devices available in a network 15.

The media source application may enable the user 12 to access and/or use media content within the media source application. The media content may reside on and/or may be provided by one or more content sources accessible to the computing device 11. For example, the media content may reside on a first content source 21 which may be connected to or may be a part of the computing device 11. For example, the first content source 21 may be electronic memory and/or an internal hard drive within the computing device 11. As another example, the first content source 21 may be removable electronic memory, such as, for example, a flash memory card as known to one skilled in the art, an external hard drive connected to the computing device 11, and/or may be a portable device with storage connected to the computing device 11. The present invention is not limited to these examples, and the first content source 21 may be any content source connected to or a part of the computing device as known to one skilled in the art.

The media content may reside on a second content source 22 which may be a remote content source available using a wide area network, such as, for example, the internet 25. For example, the second content source 22 may be a web server, a remote media server, a media content service and/or a similar source which may provide media content over a wide area network and/or the internet 25. The media content provided by the second content source 22 may be presented by, may be accessed through and/or may be associated with one or more webpages displayed in a web browser on the computing device 11. The media content provided by the second content source 22 may be provided, for example, by a media content service, an internet news service, a social networking site, a video sharing site, a photo sharing site, an online music service, an internet radio service and/or various other internet-based media content sources known to one skilled in the art.

The media content may reside on a third content source 23 which may be a local content source available on a network to which the computing device 11 is connected, such as, for example, the network 15. For example, the third content source 23 may be a personal computer, a network-attached storage (NAS) device, a media server device and/or any other local storage device capable of storing and/or providing media content in a network as known to one skilled in the art. The third content source 23 may be a Universal Plug-and-Play (UPnP) Audio Visual (AV) compatible media server and/or a DLNA compliant media server. The network 15 may be a local area network based on various networking technologies, such as, for example, wired Ethernet, IEEE 1394 (“Firewire”), IEEE 802.11 (“Wi-Fi”), Bluetooth, Multimedia over Coax (“MoCa”) and/or the like. The network 15 may be a hybrid network based on more than one networking technology; for example, the network 15 may be a combination of wired Ethernet and wireless IEEE 802.11 connections. The network 15 is not limited to using the example network technologies listed herein, and the network 15 may be based on any networking technologies known to one skilled in the art.

The media source application executed by the computing device 11 may access, may discover and/or may obtain information about the media content available from one or more content sources, such as, for example, the first content source 21, the second content source 22 and/or the third content source 23 (collectively hereafter “the content sources 21, 22, 23”). The media source application may present the media content to the user 12 as part of the tasks and/or functions for which the media source application was designed. For example, a media source application which is a web browser may display webpages which include and/or reference the media content. As a second example, a media source application which is a photo viewer may display photos and/or photo albums which correspond to media content stored on the computing device 11. As a third example, a media source application which is a music player may present information about available digital music tracks and music albums which are available for playback. The present invention is not limited to the examples of media source applications listed herein, and the present invention may utilize any media source application which may enable a user to browse, discover, retrieve, consume, play, view, create, edit, organize and/or use media content as known to one skilled in the art.

The media source application executed by the computing device 11 may utilize the OS and/or the events framework available on the computing device 11 to identify media handler applications which may provide functionality for sharing and/or transferring media content. In an embodiment, the media source application may utilize the OS and/or the events framework to identify one or more media content options which may correspond to media rendering devices accessible to the computing device 11 using the network 15, such as, for example, a first, rendering device 31, a second rendering device 32 and/or a third rendering device 33. For example, the media source application may identify options for transferring, sending, playing and/or rendering media content to the first rendering device 31, the second rendering device 32 and/or the third rendering device 33.

The media rendering devices accessible to the computing device 11 may be, for example, a networked television, a networked stereo, a set top box, a networked video adapter device, a networked audio adapter device, a digital photo frame, a desktop personal computer, a laptop personal computer, a portable computing device, a video gaming console, and/or the like. The networked video adapter device and/or the networked audio adapter device (collectively hereafter “the adapter devices”) may enable media rendering devices without network connection capabilities to be connected to the network 15. Therefore, the adapter devices may enable media rendering devices without network connection capabilities to function as networked media rendering devices. The media rendering devices and/or the adapter devices may be compliant to a media networking standard, such as, for example, the UPnP AV standard and/or the DLNA standard. For example, the media rendering device accessible to the computing device 11 may be a DLNA-compliant rendering device. The media rendering devices may be any devices capable of rendering media content as known to one skilled in the art.

The media source application may present to the user 12 the various options identified using the events framework and/or the OS for transferring, sending, playing and/or rendering media content. The user 12 may select, may choose and/or may invoke one of the options which may correspond to transferring, sending, playing and/or rendering the media content to one or more of the media rendering devices accessible to the computing device 11. In response, the media content may be transferred to, sent to, played on and/or rendered by the one or more media rendering devices accessible to the computing device 11.

Alternatively, the media source application may rely on the OS and/or the events framework to present to the user 12 the various options for transferring, sending, playing, and/or rendering media content. For example, the media source application may identify media content available in the media source application to the OS and/or to the events framework, and may indicate that the media content should be made available to media handler applications registered with the OS and/or the events framework. In addition, the media source application may indicate specific actions for which the media content should be made available; for example, the media source application may indicate that the media content should be made available for the SHARE action. Further, the media source application may provide a description of the media content when identifying the media content to the OS and/or the events framework. Then, the OS and/or the events framework may present the various options related to the identified media content to the user 12. As in the previous example, the user 12 may select, may choose, and/or may invoke one of the options which may correspond to transferring, sending, playing, and/or rendering the media content to one or more of the media rendering devices accessible to the computing device 11. In response, the media content may be transferred to, sent to, played on, and/or rendered by the one or more media rendering devices accessible to the computing device 11.

As a result, the various options to transfer, send, play, render, or perform other actions using the events framework and/or the OS may be presented to the user 12 by the media source application, by the events framework and/or by the OS. For simplicity, the various examples hereafter will assume the media source application presents the options to the user 12. However, in each example the options may be presented by the events framework and/or by the OS. Furthermore, subsequent actions, such as accepting user input and/or transmitting information related to a selected option and/or a media action, may be performed by the media source application, by the events framework and/or by the OS. One skilled in the art may recognize other variations by which the media source application may interact with an events framework and/or an OS to make media content available to media handler applications. The means by which the options are presented to the user 12 may vary depending on the design of the media source application, the events framework, and/or the OS. The present invention is not limited to a specific means by which the options are presented to the user 12.

FIG. 2 generally illustrates a system 100 for transferring media content from a media source application to a media rendering device 101 using an events framework 102 and a media handler application 103 in an embodiment of the present invention. As illustrated in FIG. 2, one or more media source applications, such as, for example, a first media source application 111, a second media source application 112, and/or a third media source application 113 (collectively hereafter “the media source applications 111, 112, 113”), may be connected to the events framework 102. As noted previously, each of the media source applications may use the events framework 102 to identify applications, services and/or handlers which may be capable of receiving and/or handling media events. For example, the media source applications 111, 112, 113 may query the events framework 102 to identify applications, services and/or handlers which may be valid destinations for events and/or actions related to transferring, sending, playing, rendering and/or sharing media content (hereinafter “media actions”).

The media handler application 103 may register with the events framework 102 and/or the OS, and/or the registration may indicate to the events framework 102 and/or the OS that the media handler application 103 is a valid handler for a media action. Further, the registration may provide additional information about the capabilities of the media handler application 103. For example, the registration may specify types of media content which the media handler application 103 may be capable of receiving and/or which may be preferred for receipt by the media handler application 103. As previously noted, the specified media content types may specify that the media content is video content, audio content, image content and/or some other classification of media content. Alternatively or additionally, the specified media content types may be more detailed. For example, the specified media content types may indicate file formats, media codecs, profiles, levels and/or MIME types which the media handler application 103 may be capable of receiving and/or which may be preferred for receipt by the media handler application 103.

One of the media source applications 111, 112, 113 may query the events framework 102 and/or the OS to identify applications, services and/or handlers appropriate for a media action. The querying media source application may specify one or more media actions in the query. For example, one of the media source applications 111, 112, 113 may specify a “SHARE” action to query for applications, services and/or handlers capable of handling the “SHARE” action for media content. The querying media source application may provide information about the media content in the query. For example, a photo viewer application which may share JPEG-encoded digital photographs may specify in a corresponding query that the media content is encoded using the JPEG image codec, is packaged using the JFIF file format, and/or has a MIME type of “image/jpg.” Thus, the events framework 102 and/or the OS may limit the query results to only include the applications, the services and/or the handlers having a registration indicating the capability to handle JPEG images.

The media handler application 103 may identify one or more media rendering devices available on the network 15. The media handler application 103 may identify the media rendering devices using one or more media communication protocols, such as, for example, the UPnP standard, the UPnP AV standard and/or the DLNA standard. The present invention is not limited to these examples of media communication protocols and may utilize any media communication protocol which identifies available media rendering devices as known to one skilled in the art.

In an embodiment, the media handler application 103 may register with the events framework 102 and/or the OS in response to identification of an available media rendering device in the network 15. The media handler application 103 may de-register from the events framework 102 and/or the OS in response to determination that a previously available media rendering device is unavailable in the network 15. The media handler application 103 may register with the events framework 102 and/or the OS in response to determination that the computing device 11 has connected to the network 15 and/or in response to detection of a network connection newly available to the computing device 11. In a preferred embodiment, the media handler application 103 may register with the events framework 102 and/or the OS in response to determination that the computing device 11 has connected to a known network, such as, for example, a home network known to the user 12, an office network known to the user 12, a network previously visited by and/or connected to the computing device 11, a network identified by the user 12 as a valid network for rendering media content and/or a network in which the media handler application 103 has detected media rendering devices.

In an embodiment, the media handler application 103 may utilize properties of the available media rendering devices when registering with the events framework 102 and/or the OS. As a first example, the media handler application 103 may only identify a single available media rendering device, and the single available media rendering device may be a DLNA-compatible digital photo frame. When registering with the events framework 102 and/or the OS, the media handler application 103 may indicate that the media handler application 103 is capable of handling only image content. The media source applications 111, 112, 113 may use the events framework 102 and/or the OS to determine that the media handler application 103 should only receive media events related to media content of type “image.” The media source applications 111, 112, 113 may provide an option to transfer, send, play, render and/or share image content using the media handler application 103. However, the media source applications 111, 112, 113 may not provide an option to transfer, send, play, render and/or share media content which is not of type “image” using the media handler application 103.

As a second example, the media handler application 103 may identify two available media rendering devices in the network 15, such as, for example, the first rendering device 31 and the second rendering device 32. The first rendering device 31 may be a DLNA-compatible digital photo frame, and/or the second rendering device 32 may be a DLNA-compliant stereo device. Then, the media handler application may register with the events framework 102 and/or the OS by combining properties of the first rendering device 31 and the second rendering device 32. For example, the media handler application 103 may indicate that it is capable of handling both image content and audio content. Then, the media source applications 111, 112, 113 may use the events framework 102 and/or the OS to determine that the media handler application 103 may receive media events related to media content which is image content and/or audio content. The media source applications 111, 112, 113 may provide an option to transfer, send, play, render and/or share image content and/or audio content using the media handler application 103. However, the media source applications 111, 112, 113 may not provide an option to transfer, send, play, render and/or share media content which is neither image content nor audio content using the media handler application 103. For example, if the first media source application 111 has video content, the first media source application 111 may not provide an option to transfer, send, play, render and/or share media content which is neither image content nor audio content using the media handler application 103.

Therefore, the events framework 102 may be used to convey information about the media types supported by the available media rendering devices into the media source applications 111, 112, 113. As a result, each of the media source applications 111, 112, 113 may present options relevant to the media content available in the media source application.

In an embodiment, the media handler application 103 may utilize detailed media capabilities of the available media rendering devices when registering with the events framework 102 and/or the OS. The media handler application 103 may receive the detailed media capabilities directly from the media rendering device 101 in the form of a media capability description. For example, the media rendering device 101 may provide the media capability description in a standard form which may comply with a known media communication protocol, such as, for example, the UPnP AV standard and/or the DLNA standard. The media capability description may be formatted in a known markup language and/or description language; for example, the media capability description may be formatted using XML, HTML, ASN.1, SDP and/or the like. The media capability description may describe media capabilities of the media rendering device 101, such as media types, file formats, codecs, profiles, levels, transport methods and/or MIME-types supported by the media rendering device 101. Then, the media handler application 103 may provide the media capabilities of one or more available media rendering devices when registering with the events framework 102 and/or the OS.

In an embodiment, the media handler application 103 may receive media capabilities from a source other than the media rendering device 101. For example, the media handler application 103 may receive identifying information directly from the media rendering device 101. The identifying information may indicate a manufacturer, a model number, a serial number, a MAC address, a UPC code and/or other information suitable for identifying the media rendering device 101. Based on the identifying information, the media handler application 103 may access a capabilities database (not shown in the figures) to retrieve some or all of the media capabilities associated with the media rendering device 101. The capabilities database may be accessible to the computing device 11 over the network 15, may be available remotely using the internet 25, may reside in local storage in the computing device 11 and/or may be any other database which stores media capabilities known to one skilled in the art.

In a preferred embodiment, the media handler application 103 may receive the identifying information and the media capability description from the media rendering device 101. Then, the media handler application 103 may obtain, may retrieve and/or may use additional media capability information from a capabilities database. Thus, the media handler application 103 may use an available capabilities database to supplement the media capability description available directly from the media rendering device 101.

For example, the media handler application may only identify a single available media rendering device, and the single available media rendering device may be a DLNA-compatible stereo device. The media handler application 103 may receive a DLNA-compliant capability description from the DLNA-compatible stereo device, and the DLNA-compliant capability description may indicate that the DLNA-compatible stereo device supports AC3 and MP3 audio codecs according to relevant audio codec profiles defined by DLNA. Further, the media handler application 103 may obtain identifying information, such as, for example, a manufacturer name, a product identifier and/or a model number received from the DLNA-compatible stereo device. The media handler application 103 may use the identifying information to obtain additional capability information for the DLNA-compatible stereo device from an available capabilities database.

For example, the additional capability information may indicate points where the capabilities of the media rendering device have been determined to not comply fully with the DLNA audio codec profiles provided by the DLNA-compatible stereo device. As another example, the additional capability information may express capabilities of the DLNA-compatible stereo device which cannot be represented in the capability format and/or the media communication protocol used by the DLNA-compatible stereo device. For example, the additional capability information may indicate that the DLNA-compatible stereo device supports Ogg Vorbis audio files, and the DLNA media format specification may not provide a means to express support for Ogg Vorbis audio files. Then, when registering with the events framework 102 and/or the OS, the media handler application 103 may indicate that the media handler application 103 is capable of handling audio content with MIME types of audio/vnd.dolby.dd-raw, audio/mpeg and audio/vorbis corresponding to AC3 content, MP3 content and Ogg Vorbis audio content, respectively.

The media handler application 103 may discover, may retrieve, may obtain and/or may receive detailed capability information corresponding to multiple available media rendering devices. The detailed capability information may be received directly from each of the available media rendering devices, may be obtained from a capabilities database, and/or may be a combination of capability information received from each of the available media rendering devices and from one or more capabilities databases. The media handler application 103 may combine the detailed capability information associated with the multiple available media rendering devices to describe aggregate media capabilities of the multiple available media rendering devices. Then, when registering with the events framework 102 and/or the OS, the media handler application 103 may provide the aggregate media capabilities of the multiple available media rendering devices. Thus, the media source applications 111, 112, 113 may associate the media handler application 103 with the aggregate capabilities corresponding to the multiple available media rendering devices identified by the media handler application 103. Each of the media source applications 111, 112, 113 may provide options to transfer, send, play, render and/or share the media content available in the media source application using the media handler application 103 only if the media handler application 103 has identified at least one of the available media rendering devices as capable of rendering the media content.

In an embodiment, the media handler application 103 may receive updates regarding the available media rendering devices. For example, the media handler application 103 may determine that a previously available media rendering device is no longer available, that a previously unavailable media rendering device has become available and/or that the media capabilities of a media rendering device were updated and/or changed. One or more of the updates may be communicated by the media rendering devices. For example, a previously unavailable media rendering device which becomes available may broadcast an availability announcement over the network 15. One or more of the updates may be obtained by the media handler application 103 requesting information from the media rendering devices. For example, the media handler application 103 may periodically query the media rendering devices to verify that each of the media rendering devices continues to be available and/or to determine whether updated capability and/or status information may be available from the media rendering devices.

If the media handler application 103 receives updated information about the availability, the media capabilities and/or the status of the media rendering devices, the media handler application 103 may update the registration with the events framework 102 and/or the OS to reflect updated aggregate media capabilities of the multiple available media rendering devices. Thus, each of the media source applications 111, 112, 113 may obtain current information about the media capabilities which may be handled by the media handler application 103 as the media capabilities and/or the media rendering devices available change dynamically.

In an embodiment, the media handler application 103 may de-register from the events framework 102 and/or the OS. The media handler application 103 may de-register in response to determination that one or more of the previously available media rendering devices are no longer available. Alternatively or additionally, the media handler application 103 may de-register in response to the computing device 11 disconnecting from the network 15.

The media handler application 103 may be notified of a media action originating from any of the media source applications 111, 112, 113. For example, the first media source application 111 may provide an option to SHARE specific media content available in the first media source application 111 using the media handler application 103. The user 11 may select and/or may invoke the option offered by the first media source application 111. In response, the first media source application 111 may initiate a media action to SHARE the specific media content using the media handler application 103.

The media handler application 103 may be running “in the background” on the computing device 11 and, accordingly, may be always ready to participate in media actions. If the computing device 11 is not executing the media handler application 103, the first media source application 111, the events framework 102 and/or the OS may create, may initiate and/or may execute the media handler application 103 in response to initiation of the media action. In an embodiment, the computing device 11 may initiate execution of the media handler application 103 in response to the computing device 11 connecting to the network 15, connecting to a known network and/or discovering the availability of a media rendering device.

In an embodiment, the media handler application 103 may have a default registration with the events framework 102. The default registration may associate the media handler application 103 with a media action, such as, for example, a SHARE action, for media content. However, the default registration may not identify restrictions based on media type and media capabilities.

In this embodiment, the SHARE option associated with the media handler application 103 may be available to the media source applications 111, 112, 113 while the computing device 11 is not executing the media handler application 103. Thus, the media source application 103 may generate a SHARE action for media content using the media handler application 103 while the media handler application 103 is not running. In response, the computing device may initiate use of the media handler application 103. Then, the media handler application 103 may determine whether the computing device 11 is connected to a network; may determine the availability of, the capabilities of and/or the status of the media rendering devices; and/or may update the registration with the events framework 102 and/or the OS to provide updated aggregate media capabilities of the multiple available media rendering devices. Further, the media handler application 103 may determine whether an available media rendering device is capable of rendering the media content included in and/or referenced by the media action. If an available media rendering device is capable of rendering the media content included in and/or referenced by the media action, the media handler application 103 may proceed to handle the media action. If none of the available media rendering devices are capable of rendering the media content included in and/or referenced by the media action, the media handler application 103 may indicate an error condition and/or may indicate that no suitable media rendering device is currently available as discussed in further detail hereafter.

The media handler application 103 may be notified of the SHARE action for the specific media content. The media handler application 103 may be notified of the SHARE action directly by the corresponding media source application (path not shown in FIG. 2) or the media handler application 103 may be notified of the SHARE action by the events framework 102 and/or the OS. The SHARE action may be indicated to the media handler application 103. Further, the media content and/or a reference to the media content may be indicated to the media handler application 103. For example, the media action may involve a media file, a media content object, a handle of a media content object, a URL identifying a media content object and/or the like. The media action may involve multiple media content objects. For example, the media action may involve multiple media content objects, multiple handles and/or multiple URLs. Alternatively, a composite object may identify multiple media content objects. For example, a playlist may identify multiple audio files, and/or a slideshow may contain multiple digital photographs. The media handler application 103 may receive information about the media type of the media content to SHARE. For example, one or more MIME types corresponding to the media content may be specified. Alternatively, the media handler application 103 may not receive information about the media type of the media content.

The media handler application 103 may determine an appropriate media rendering device for rendering the media content included in and/or referenced by the media action. For example, the media handler application 103 may examine a description of the media content included in the media action, and/or the media handler application 103 may retrieve some or all of the media content from a content source to determine the type of media content and/or properties of the media content. The media handler application 103 may compare the description, the type, and/or the properties of the media content to the media capabilities of the available media rendering devices to select a media rendering device suitable for rendering the media content included in and/or specified by the media action. In an embodiment, the media handler application 103 may transfer the media content and/or a reference to the media content to the media rendering device without interacting with the user 12. The reference to the media content may be, for example, a URL.

In another embodiment, the media handler application 103 may request that the user 12 provide user input directing the media rendering device to render the media content. In response to user input directing the media rendering device to render the media content, the media handler application 103 may transfer the media content and/or a reference to the media content to the media rendering device.

In another embodiment, the media handler application 103 may identify multiple media rendering devices suitable for rendering the media content and/or may enable the user 12 to select one of the multiple media rendering devices suitable for rendering the media content. In response to user input which selects one of the multiple media rendering devices suitable for rendering the media content, the media handler application 103 may transfer the media content and/or a reference to the media content to the selected media rendering device.

The media rendering device may obtain the media content from the media handler application 103, from the media source application 111, and/or from a content source 105. The content source 105 may be any suitable content source known to one skilled in the art, and the present invention is not limited to a specific embodiment of the content source 105. For example, the content source 105 may be one of the content sources 21, 22, 23. The form and the location of the content source 105 may depend on the embodiment of the media source application. For example, if the media source application is a web browser, the content source 105 may be a remote server which may be associated with a webpage, and the media source application may provide a URL to a media file available from the remote server. As another example, if the media source application is a photo browser, the media source application may provide a handle to a media object which may be a digital photograph stored locally on the computing device 11. One skilled in the art will recognize various other content sources which may store and/or provide media content specified in a media action.

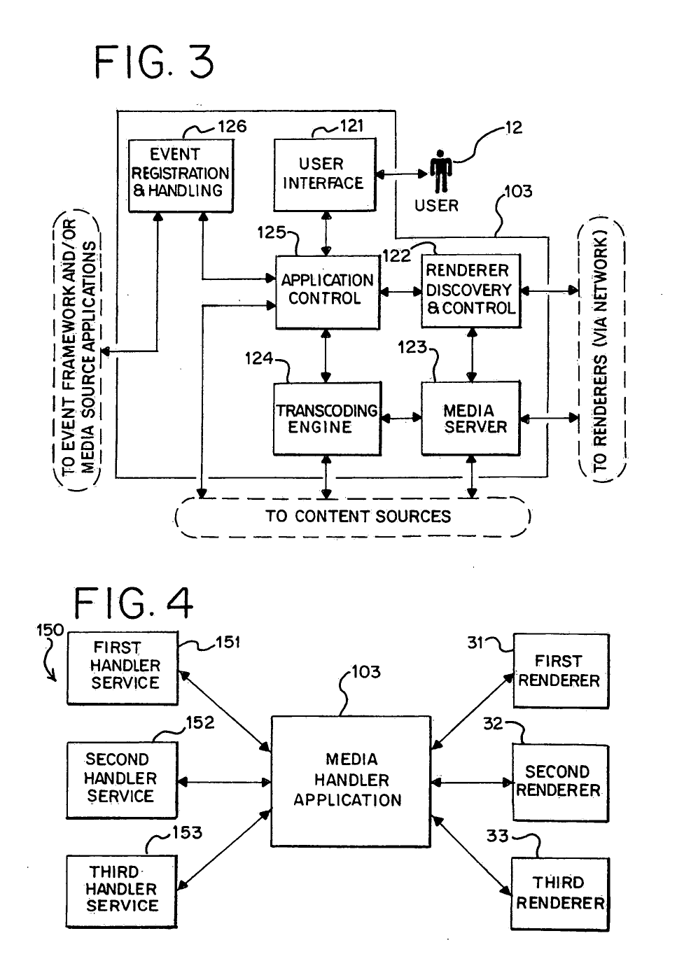

FIG. 3 generally illustrates the media handler application 103 in an embodiment of the present invention. The media handler application 103 may have a user interface 121 which may be presented using a display associated with the computing device 11. Further, the user interface 121 may accept user input using any user input methods available on the computing device 11. For example, the user interface 121 may utilize a keyboard, a mouse, a numeric keypad, soft keys, buttons, a touchscreen, a directional pad, a joystick, a trackball, a game controller, an infrared remote control device and/or any other method of accepting user input and/or controlling the user interface 121 known to one skilled in the art.

In response to a media action initiated by one of the media source applications 111, 112, 113, such as, for example, a SHARE action, the user interface 121 may enable the user 11 to select one of the multiple media rendering devices suitable for rendering the corresponding media content. The user interface 121 may display an error message. For example, the user interface 121 may display a message to indicate that none of the available media rendering devices is capable of rendering the media content included in and/or specified by the media action. As another example, the user interface 121 may display a message to indicate a problem transferring the media content to and/or rendering the media content on a media rendering device. The user interface 121 may enable the user 12 to control rendering of the media content on a media rendering device suitable for rendering the media content. For example, the user interface 121 may provide media rendering controls, such as, for example, “play,” “pause,” “stop,” “fast forward,” “rewind,” “skip forward,” “skip backward,” “volume up,” “volume down,” “mute” and/or the like. The media rendering controls may be any controls for controlling the rendering of media content known to one skilled in the art, and the present invention is not limited to a specific embodiment of the media rendering controls.

The user interface 121 may enable the user 12 to configure the media handler application 103. For example, the user interface 121 may enable the user 12 to specify one or more networks in which the media handler application 103 should operate. The user interface 121 may enable the user 12 to specify preferred media rendering devices. For example, the user interface 121 may enable the user 12 to specify a first preferred rendering device for audio content, a second preferred rendering device for video content and/or a third preferred rendering device for image content. Each of the first preferred rendering device, the second preferred rendering device and/or the third preferred rendering device may be a different device than the other preferred rendering devices. Further, the user interface 121 may enable the user 12 to specify one or more media rendering devices not to be used by the media handler application 103.

The media handler application 103 may provide the user interface 121 if the user interface 121 is needed and/or may not provide the user interface 121 if the user interface 121 is not needed. For example, the media handler application 103 may present the user interface 121 if user input is required to select one of multiple media rendering devices suitable for rendering the corresponding media content for a SHARE action.

As another example, the media handler application may provide the user interface 121 during use of the media handler application 103 to render media content and/or when the user 12 actively controls the rendering of media content using the media rendering controls. As yet another example, the media handler application 103 may not provide the user interface 121 after completion of rendering of the media content, and/or control of the display and/or the user input methods may be returned to the media source application which initiated the SHARE action.

The media handler application 103 may have a renderer discovery and control component 122 (hereinafter “the RDC component 122”). The RDC component 122 may determine the availability of, the media capabilities of and/or the status of the available media rendering devices. Further, the RDC component 122 may initiate, may maintain and/or may control delivery of the media content to and/or rendering of the media content by a media rendering device suitable for rendering the media content.

For example, the RDC component 122 may determine the available media rendering devices in the network 15. The RDC component 122 may determine the media capabilities of the available media rendering devices in the network 15. The available media rendering devices in the network 15 may transmit messages in the network 15 to communicate the availability and/or the capabilities to other devices in the network 15. The RDC component 122 may receive the messages from the available media rendering devices. The RDC component 122 may use the network 15 to communicate with the available media rendering devices to determine a current status of the available media rendering devices and/or to determine additional capabilities for the available media rendering devices. The RDC component 122 may access additional sources, such as, for example, a capabilities database, to determine the capabilities and/or the additional capabilities of the available media rendering devices. The capabilities and/or the additional capabilities may indicate the media capabilities for the available media rendering devices.

The RDC component 122 may create, may maintain and/or may update an internal list of the available media rendering devices in the network 15. The internal list may have the media capabilities of the available media rendering devices. The media capabilities of the available media rendering devices may have and/or may be, for example, media types, such as, for example, audio, video and/or image; multimedia codecs, such as, for example, AAC Audio codec, H.264 video codec and/or the like; profiles and/or levels associated with the multimedia codecs; file formats, such as, for example, 3GPP file format, MP4 file format, FLV file format and/or the like; transport methods; and/or digital rights management (“DRM”) technologies which may be supported by the available media rendering devices. The present invention is not limited to a specific embodiment of the media capabilities which may be determined by the RDC component 122.

In response to a media action initiated by a media source application, the media handler application 103 may use the RDC component 122 and/or the information previously collected by the RDC component 122 to select and/or to identify a target rendering device for rendering the media content for the media action. The RDC component 122 may communicate with the target rendering device. The RDC component 122 may instruct the target rendering device to request, to retrieve, to process and/or to render one or more media content objects. The RDC component 122 may specify a location from which each of the media content objects may be retrieved by the target rendering device. The location may specify a local content source in the network 15, local storage in the computing device 11, a remote server associated with a media content site, a media server component 123 of the media handler application 103 discussed in more detail hereafter, and/or the like. The location may be a URL, such as, for example, an HTTP URL, an RTSP URL and/or the like.

The RDC component 122 may communicate with the target rendering device to control the rendering of the one or more media content objects. For example, the RDC component 122 may control the rendering of one or more media content objects by the target rendering device in accordance with the media rendering controls which may be presented by the media handler application 103 in the user interface 121 and/or which may be accessed, may be invoked and/or may be used by the user 11. The RDC component 122 may transmit rendering control instructions to the target rendering device. In an embodiment, the RDC component 122 may be and/or may act as a UPnP AV Control Point and/or a DLNA Control Point. The RDC component 122 may communicate with multiple target rendering devices, and the RDC component 122 is not limited to communication with one target rendering device.

The media handler application 103 may have a transcoding engine 124 which may transcode, may reformat and/or may repurpose the media content for compatibility with an available media rendering device. The transcoding engine 124 may receive instructions specifying media content to transfer to, send to and/or render on a specific media rendering device. The transcoding engine 124 may communicate with the RDC component 122 to determine the media capabilities of the target rendering device. The transcoding engine may access the media content from the content source which provides the media content. As previously discussed, the content source may be local storage within the computing device 11, may be a local storage device in the network 15, may be a remote server accessible using the internet 25, and/or the like.

The transcoding engine 124 may process the media content to prepare the media content for delivery to the target rendering device. The transcoding engine 124 may transcode the media content based on the media capabilities of the target rendering device. For example, the transcoding engine 124 may transcode the media content to produce transcoded media content which may conform to media codecs, profiles and/or levels which may be supported by the target rendering device. The transcoding engine 124 may reformat the media content. For example, the transcoding engine 124 may reformat the media content to produce reformatted media content which may have a file format and/or a delivery format appropriate for the target rendering device.

The transcoding engine 124 may examine the DRM protection, if any, of the media content to determine restrictions for transferring the media content to and/or rendering the media content on the target rendering device. The transcoding engine 124 may determine that the restrictions require secure transfer of the media content to the target rendering device. The transcoding engine 124 may reformat the media content for secure transfer to the target rendering device, and/or the transcoding engine 124 may inform the media server component 123 that the secure transfer may be required. The reformatting for and/or the communication about the secure transfer may reflect a specific method of secure transfer which may be required by the restrictions. The transcoding engine 124 may determine that the restrictions for the media content do not permit transferring the media content to and/or rendering the media content on the target rendering device. The transcoding engine 124 may not permit transfer of the media content to and/or rendering of the media content on the target rendering device. The media handler application 103 may indicate to the user 12 that transfer of the media content to and/or rendering of the media content on the target rendering device may not be allowed due to the restrictions.

In an embodiment, the transcoding engine 124 may not be available in and/or may not be provided by the media handler application 103. In this embodiment, an application control component 125 discussed in more detail hereafter and/or the RDC component 122 may determine whether the media content for a media action may be rendered on any of the available media rendering devices. In this embodiment, transcoding capabilities may not be available, and/or only the native media capabilities of the available media rendering devices may be considered in the determination of whether the media content for a media action may be rendered on any of the available media rendering devices.

The media handler application may have the media server component 123 which may receive and/or may access the media content to make the media content available to one or more of the available media rendering devices. For example, the media content may be present in local storage on the computing device 11, and/or a standard media server component may be necessary to make the media content available to the media rendering devices. The media content may be transcoded, reformatted and/or repurposed media content received from the transcoding engine 124. Alternatively, the media content may not have been transcoded, reformatted and/or repurposed. The media content may be media content retrieved from a remote server associated with an internet media content site and/or a media content service. The media content may be any media content accessible to the media handler application 103.

For example, the media server component 123 may be and/or may act as a web server, an RTSP media server, a UPnP AV media server, a DLNA compliant media server, an HTTP Proxy Server and/or any media server known to one having ordinary skill in the art. The present invention is not limited to a specific embodiment of the media server component.

The media server component 123 may deliver the media content to the target rendering device using the network 15. The media server component 123 may store and/or may buffer a portion and/or an entirety of the media content. The media server component 123 may be visible to and/or may be accessible to media rendering devices, portable media players, other media destinations, control points and/or multimedia clients which may be accessible to the media handler application 103 using the network 15 and/or other means.

The media server component 123 may identify, may indicate availability of and/or may provide access to the media content included in, specified by and/or referenced by media actions initiated by the media source applications 111, 112, 113. The media server component 123 may indicate the availability of the media content using a folder hierarchy. For example, the media server component 123 may provide a “Current Share” folder to indicate media content which corresponds to current and/or recent media events received by the media handler application 103.

In an embodiment, the media server component 123 may make the media content, persistently available. For example, the media server component 123 may provide a “history” folder which indicates availability of media content from past media actions handled by the media handler application 103. Then, a media rendering device and/or a control point may access the media server component 123 to browse, discover, and/or access the media content indicated and/or advertised in the “history” folder. The media server component 123 may provide additional folders to access media content alphabetically, by media type, by genre and/or by any other organizational convention known to one skilled in the art.

The media server component 123 may indicate the availability of the media content. Further, the media server component 123 may provide access to the media content to the target rendering device, to other media rendering devices and/or to other devices, such as, for example, portable media players, control points and/or multimedia clients. The media server component 123 may indicate the availability of the media content and/or may provide the access to the media content regardless of whether the media handler application 103 is being actively used. Thus, the user 12 may identify, may select and/or may access the media content, such as, for example, the internet media content, directly from the media rendering devices, the portable media players, the control points, the multimedia clients and/or other devices available in the network 15.

The media handler application 103 may have the application control component 125. The application control component 125 may communicate with the user interface 121, the RDC component 122, an event registration and handling component 126 discussed in more detail hereafter, the media server component 123, the transcoding engine 124 and/or other components of the media handler application 103. As a result, the application control component 125 may control and/or may coordinate the components of the media handler application 103 to handle the media actions and/or to render the media content on media rendering devices suitable for rendering the media content.

The application control component 125 may provide logic to process incoming media actions. Further, the application control component 125 may provide logic to determine whether media content is renderable on a media rendering device based on properties of the media content and the media capabilities of the media rendering device. Still further, the application control component 125 may provide logic to determine whether media content may be transcoded for compatibility with a media rendering device based on the properties of the media content, the media capabilities of the media rendering device and the transcoding capabilities of the transcoding engine 124. Still further, the application control component 125 may provide logic to combine capability information from multiple media rendering devices to determine the aggregate media capabilities used in a registration with the events framework 102 and/or the OS. Moreover, the application control component 125 may provide logic to support any of the operations and tasks of the media handler application 103 described herein.

The application control component 125 may provide storage for records and/or state information associated with the operation and/or tasks of the media handler application 103. For example, the application control component 125 may store records which track current and/or previous registrations with the events framework 102 and/or the OS. As another example, the application control component 125 may store records of the availability of, the capabilities of and/or the status of media rendering devices in the network 15. As yet another example, the application control component 125 may store records of current and/or past events received from the media source applications 111, 112, 113, the events framework 102 and/or the OS. The embodiment of the application control component 125 is not limited to these examples, and the application control component 125 may store various other records and/or state information relating to the operation and/or tasks of the media handler application 103.

The media handler application 103 may have the event registration and handling component 126 (hereinafter the “ERH component 126”). The ERH component 126 may communicate with the events framework 102 and/or the OS to register for media actions. The registration may include an identifier for the media handler application 103, a name for the media handler application 103, a text element which describes the media handler application 103, a graphic symbol and/or icon associated with the media handler application 103, a list of one or more media actions which the media handler application 103 is capable of receiving, handling, and/or processing, and/or a description of media capabilities and/or media content types associated with the media handler application 103. As previously discussed, the description of the media capabilities and/or the media content types may reflect the media capabilities and/or the content types associated with available media rendering devices. In an embodiment, the description of media capabilities and/or media content types may reflect the aggregate media capabilities and/or content types of the multiple available media rendering devices. In another embodiment, the description of media capabilities and/or media content types may include the aggregate media capabilities and/or content types of the multiple available media rendering devices extended to include the transcoding capabilities of the transcoding engine 124.

In an embodiment, the ERH component 126 may communicate with the events framework 102 and/or the OS to create separate registrations corresponding to multiple handler services associated with the media handler application 103. For each of the separate registrations, the ERH component 126 may provide a registration identifier; a handler service identifier; a handler service name; a text element which describes the handler service; a graphic symbol and/or icon associated with the handler service; a list of one or more media actions which the handler service is capable of receiving, handling and/or processing; and/or a description of media capabilities and/or media content types associated with the handler service.

In an embodiment, a registration and the handler service associated with the registration may correspond to one media rendering device. In another embodiment, a registration and the handler service associated with the registration may correspond to two or more media rendering devices. In yet another embodiment, a registration and the handler service associated with the registration may correspond to a profile configured by the user 12, and the profile may be associated with one or more media rendering devices and one or more settings specified by the user 12. An embodiment may combine registrations of these various types. For example, the ERH component 126 may create registrations corresponding to each of the available media rendering devices and/or may create a registration corresponding to the combination of two available media rendering devices, such as, for example, two DLNA-compatible stereo devices. Additional description and examples are provided hereafter for registrations corresponding to individual media rendering devices, multiple media rendering devices and/or user-defined profiles.

The ERH component 126 may communicate with the events framework 102 and/or the OS to de-register and/or to cancel previous registrations. For example, the ERH component 126 may de-register and/or may cancel a previous registration in response to detection that the computing device 11 is no longer connected to the network 15 and/or in response to detection that a previously available media rendering device is no longer available. The ERH component 126 may communicate with the events framework 102 and/or the OS to update previous registrations. For example, the ERH component 126 may update a previous registration to reflect updated capability information and/or updated status information provided by a media rendering device. As another example, the ERH component 126 may update a previous registration to modify the media capability information associated with the previous registration in response to detection of a media rendering device becoming available, detection of a previously available media rendering device becoming unavailable and/or in response to a change in the status of the connection between the computing device 11 and the network 15.

In an embodiment, the ERH component 126 may communicate with the events framework 102 and/or the OS to create a default registration associated with the media handler application 103. The default registration may not specify media capabilities and/or media types associated with the media handler application 103, and/or the default registration may indicate that the media handler application 103 is capable of handling any media type without restriction. The default registration may enable the media handler application 103 to be identified by a media source application when the computing device 11 is not executing the media handler application 103, when the media handler application 103 does not have current and/or updated information about available media rendering devices, and/or when no media rendering devices are available.

In an embodiment, the ERH component 126 may include information about the status of a media rendering device in the initial registration and/or in an updated registration. For example, the ERH component 126 may have text indications of status, such as “busy,” “available,” “unavailable,” “in use,” “off,” and/or the like. The ERH component 126 may include the text indications of status in one or more text fields provided in the registration. For example, the ERH component 126 may include the text indications of status in the name for the media handler application 103 or the handler service, and/or the ERH component 126 may include the text indications of status in the text element which describes the media handler application 103 or handler service. In an embodiment, the ERH component 126 may provide a graphic symbol and/or icon which may indicate and/or may reflect the status of a media rendering device. For example, the graphic symbol which represents a DLNA-compatible television may be modified with a superimposed “X” to indicate that the DLNA-compatible television is currently unavailable. One skilled in the art will recognize various other text indications and/or graphic representations which may be provided in the registration to indicate the availability and/or status of a media rendering device.

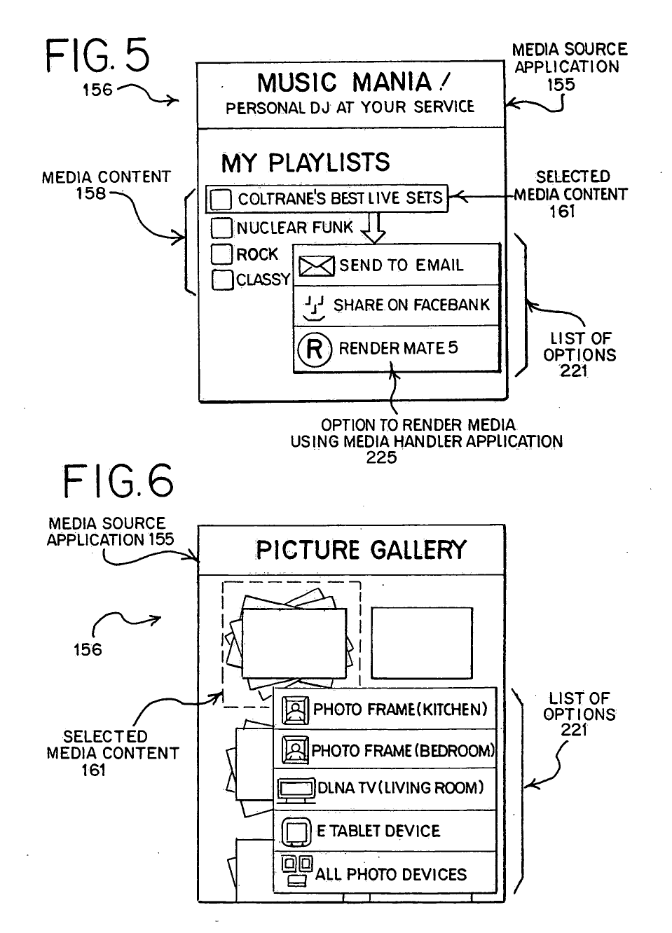

FIG. 4 generally illustrates a system 150 for transferring media content from a media source application to a rendering device by registering multiple handler services with the events framework 102 and/or the OS in an embodiment of the present invention. The media handler application 103 may identify one or more available media rendering devices, such as, for example, the first rendering device 31, the second rendering device 32 and/or the third rendering device 33. For example, the RDC component 122 of the media handler application 103 may identify the available media rendering devices and may obtain capability information, media capabilities and/or status for the available media rendering devices. The media handler application 103 may combine the capability information and/or the media capabilities from the available media rendering devices to produce an aggregate set of capabilities, media capabilities and/or media types. Then, the media handler application 103 may register with the events framework 102 and/or the OS based on the aggregate set of capabilities, media capabilities and/or media types. For example, the ERH component 126 of the media handler application 103 may register with the events framework 102 and/or the OS.

The registration may be a single registration representing the aggregate set of capabilities of the media handler application 103 and the available media rendering devices. The single registration may represent the media handler application 103, and/or a media source application may initiate a media action, such as a SHARE action, for the media handler application 103. The media source application may involve the media handler application 103 in the media action directly or may use the events framework 102 and/or the OS to involve the media handler application 103 in the media action. Alternatively, the single registration may represent a handler service associated with the media handler application 103.

For example, the single registration may represent a first handler service 151. In this case, a media source application may involve the first handler service 151 in the media action, whether directly or indirectly using the events framework 102 and/or the OS. In response, the first handler service 151 may involve the media handler application 103 in the media action and/or may transmit information for the media action to the media handler application 103.

The media handler application 103 may create, may initiate, may have and/or may use multiple media handler services, and/or each of the multiple media handler services may be separately registered with the events framework 102 and/or the OS. For example, the media handler application 103 may have the first handler service 151, a second handler service 152 and/or a third handler service 153. The present invention is not limited to a number of media handler services associated with the media handler application 103, and any number of media handler services may be associated with the media handler application 103.

A media source application may use the events framework 102 to identify the multiple handler services associated with the media handler application 103. Further, the media source application may determine that each of the multiple handler services is associated with different media capabilities, media types, media-related actions and/or media actions in accordance with the information provided by the media handler application 103 when registering each of the multiple handler services. Still further, the media source application may determine that each of the multiple handler services has a distinct handler service identifier, a distinct name, a distinct text description and/or a distinct graphic symbol and/or icon. Therefore, a media source application may use each of the multiple handler services as a distinct handler service having its own associated media capabilities, media types and/or identifying and/or descriptive information.

A media handler service may be associated with a media rendering device. For example, the media handler application 103 may create a media handler service to represent a DLNA-compatible photo frame available in the network 15. The media handler application 103 may register the media handler service using information about the DLNA-compatible photo frame. For example, the media handler service name, the text description of the media handler service, and/or the graphic symbol and/or icon provided at registration may be descriptive of the DLNA-compatible photo frame. Further, the media capabilities and/or the media types provided at registration may reflect the media capabilities of the DLNA-compatible photo frame. For example, the registration may provide a list of image content types supported by the DLNA-compatible photo frame. As a result, a media source application may use the events framework 102 to determine image content types which the media handler service supports and/or may offer the user 12 an option to SHARE image content available in the media source application using the media handler service.

In presenting the option, the media source application may display information descriptive of the DLNA-compatible photo frame. For example, the media source application may display the media handler service name, the text description of the media handler service, and/or the graphic symbol and/or icon associated with the media handler service. As a result, the user 12 may associate the option to SHARE the image content with the DLNA-compatible photo frame represented by the media handler service.

In an embodiment, the media handler application 103 may have multiple handler services which represent media rendering devices. In the example illustrated in FIG. 4, the first handler service 151 may represent the DLNA-compatible photo frame, the second handler service 152 may represent a DLNA-compatible stereo device, and/or the third handler service 153 may represent a DLNA-compatible set-top box connected to a television. The media handler application 103 may periodically create, destroy and/or update the media handler services and their associated registrations to reflect the state of the network 15 and the availability, capabilities and status of the media rendering devices.

The multiple media handler services may not represent different types of media rendering devices, and the multiple media handler services may not represent rendering devices with different media capabilities. For example, the first handler service 151 may represent a first DLNA-compatible television, the second handler service 152 may represent a second DLNA-compatible television, and/or the third handler service 153 may represent a third DLNA-compatible television. The media handler application 103 may have identified these three televisions as available in the network 15. In this case, a media source application may identify the three media handler services and/or may provide separate options to the user 12 for each of the three televisions.

In an embodiment, the media handler application may have a media handler service representing a group of media rendering devices. For example, the group of media rendering devices may be a set of digital photo frames available in a home network. As another example, the group of media rendering devices may be two DLNA-compatible stereo devices and an audio adapter device connected to a stereo without network connection capabilities. The media rendering devices which compose the group of media rendering devices may be located in different locations. For example, the group may include one DLNA-compatible stereo device located in the living room of a house and a second DLNA-compatible stereo device located in the kitchen of the house. The composition of the group of rendering devices is not limited to these examples, and the group of rendering devices may be any combination of two or more renderering devices available in the network 15.

The media handler application 103 may create a media handler service to represent a group of media rendering devices and/or may register the media handler service with the events framework 102 and/or the OS. When registering the media handler service, the media handler application 103 may provide information descriptive of the group of media rendering devices. For example, the name of the media handler service may be registered as “All Photo Frames” to indicate that the media handler service represents all of the photo frame devices available in the network 15. As another example, the graphic symbol and/or icon provided by the media handler application 103 at registration may depict multiple media rendering devices in combination. Further, when registering the media handler service, the media handler application 103 may provide media capabilities and/or media types which represent the capabilities and/or media types common to all of the media rendering devices in the group of media rendering devices. As a result, the media capabilities and/or the media types may describe and/or may reflect media content renderable on all of the media rendering devices in the group of media rendering devices.

A media source application may use the events framework 102 and/or the OS to identify the media handler service and/or the media capabilities and/or the media types for which the media handler service was registered. The media source application may determine that media content available in the media source application may be compatible with the media handler service. For example, the media source application may determine that a playlist referencing multiple MP3 music files may be compatible with a media handler service representing two DLNA-compatible stereo devices. The registration for the media handler service may have listed MP3 music files as a media content type supported by the media handler service because both DLNA-compatible stereo devices may have indicated support for MP3 music files. The media source application may provide an option for a SHARE action for the playlist of MP3 music files using the media handler service while displaying information descriptive of the group of two DLNA-compatible stereo devices represented by the media handler service.

The user 12 may select and/or invoke the option for the SHARE action for the playlist of MP3 music files using the media handler service. In response, the media source application may involve the media handler service in the SHARE action. Then, the media handler service may involve the media handler application 103 in the SHARE action and/or may transmit information about the SHARE action to the media handler application 103. Then, the media handler application 103 may simultaneously render the playlist of MP3 music files on both of the DLNA-compatible stereo devices. For example, the RDC component 122 of the media handler application 103 may transmit the playlist to the two DLNA-compatible stereo devices and/or may direct each of the two DLNA-compatible stereo devices to initiate rendering the MP3 music files referenced by the playlist.

As another example, the media handler application 103 may have and/or may register a media handler service representing three DLNA-compliant photo frames. A media source application may use the events framework 102 to identify the media handler service and the associated media capabilities and/or media types which may reflect the image rendering capabilities common to the three DLNA-compliant photo frames. The media source application may provide an option to the user 12 for a SHARE action for a set of digital photographs using the handler service. The SHARE action may include information descriptive of the three DLNA-compliant photo frames as provided at registration, and/or the SHARE action may appear to the user 12 as an option to render the digital photographs on all three DLNA-compliant photo frames.

The user 12 may select and/or invoke the SHARE action presented by the media source application. In response, the media source application may involve the media handler service in the SHARE action. Then, the media handler service may involve the media handler application 103 in the SHARE action and/or may transmit information about the SHARE action to the media handler application 103. Then, the media handler application 103 may instruct all three DLNA-compliant photo frames associated with the media handler service to render the digital photographs. The media handler application 103 may transfer the digital photographs to all three DLNA-compliant photo frames. The three DLNA-compliant photo frames may separately render the digital photographs; for example, each of the three DLNA-compliant photo frames may render a slide show of the digital photographs in a continuous loop after the digital photographs are transferred. As a result, the user 12 may have an option to render media content available in a media source application to multiple media rendering devices simultaneously, and/or the multiple media rendering devices may be represented by a single option identified by the media source application using the events framework 102 and/or the OS.

In an embodiment, the media handler application 103 may automatically create and/or configure a group of multiple media rendering devices for association with a single media handler service. For example, the media handler application 103 may detect multiple digital photo frames in the network 15, and/or the media handler application 103 may determine that the digital photo frames may have similar image rendering capabilities. More generally, the media handler application 103 may detect multiple rendering devices having similar and/or common media rendering capabilities. The media handler application 103 may automatically create and/or configure a group for the multiple rendering devices having similar and/or common media rendering capabilities.

In an embodiment, the media handler application 103 may enable the user 12 to create and/or configure a group of multiple media rendering devices for association with a single media handler service. For example, the user interface 121 of the media handler application 103 may provide a list of media rendering devices available in the network 15 and/or may enable the user 12 to select two or more of the media rendering devices to be used together as a group. As a result, the media handler application 103 may create, may initiate, may have and/or may register a media handler service to represent the combination of the media rendering devices selected by the user 12.

A media handler service may represent a profile. For example, the media handler service may represent a profile defined by the user 12 using the user interface 121 of the media handler application 103. The profile may specify one or more media rendering devices and one or more settings. For example, the user 12 may have a “TV” profile and a “Home Theater” profile which both may be associated with a DLNA-compatible television in the living room of the home of the user 12. The “TV” profile may specify settings for the television, such as, for example, a volume level of 25%, a brightness level of 75% and/or a surround sound setting of “OFF.” The “Home Theater” profile may specify different settings for the television, such as, for example, a volume level of 60%, a brightness level of 50% and/or a surround sound setting of “ON.” Each setting may be associated with a setting name, a setting identifier and/or a value. The setting identifier may be used to identify the setting to a device.

The settings associated with a profile may reflect additional settings, such as, for example, home automation settings, which may not be relevant to the media rendering device. For example, the “TV” profile may specify a room lighting setting of 50% and/or a window shade setting of “UP,” and/or the “Home Theater” profile may specify a room lighting setting of 5% and/or a window shade setting of “DOWN.” The user 12 may create and/or may define the profiles using the user interface 121 of the media handler application 103.

The media handler application 103 may create, may initiate, may have and/or may register a separate media handler service for each of the profiles. For example, the media handler application may create and/or may register a first media handler service for the “TV” profile and a second handler service for the “Home Theater” profile. In registering the media handler services which correspond to profiles, the media handler application 103 may provide distinct media handler service identifiers and/or may provide descriptive information to enable the user 12 to distinguish between the profiles. For example, the media handler application 103 may include the text string “TV Profile” in a text field when registering the first media handler service and/or may include the text string “Home Theater Profile” when registering the second media handler service. As a result, a media source application may present options for a SHARE action for media content based on the different profiles, such as, for example, the profiles created and/or defined by the user 12.

The user 12 of the media source application may select an option associated with one of the profiles. In response, the media source application may involve the media handler service associated with the profile in the media action corresponding to the option. The media handler service associated with the profile may involve the media handler application 103 in the media action and/or may transmit information about the media action to the media handler application 103. Then, the media handler application 103 may handle the media action by rendering the media content of the media action using the one or more media rendering devices associated with the profile and/or by implementing the settings associated with the profile.

For example, the media handler application 103 may participate in a SHARE action for a video file using the “Home Theater” profile. The media handler application 103 may render the video file on the DLNA-compatible television associated with the “Home Theater” profile. For example, the RDC component 122 of the media handler application 103 may communicate with the DLNA-compatible television to instruct the DLNA-compatible television to retrieve the video file from the content source where the video file resides and to subsequently begin rendering the video file. Additionally, the RDC component 122 of the media handler application 103 may instruct the DLNA-compatible television to establish the volume level at 60%, the brightness level at 50% and/or the surround sound setting at “ON” in accordance with the settings specified for the “Home Theater” profile. Further, the media handler application 103 may communicate with a home automation system to establish the room lighting setting at 5% and/or the window shade setting at “DOWN” in accordance with the home automation settings specified for the “Home Theater” profile. As a result, the media content specified for the media action may be transferred to and/or rendered on the DLNA-compatible television, and/or the settings specified for the “Home Theater” profile may be applied to the DLNA-compatible television and/or to the home automation system.

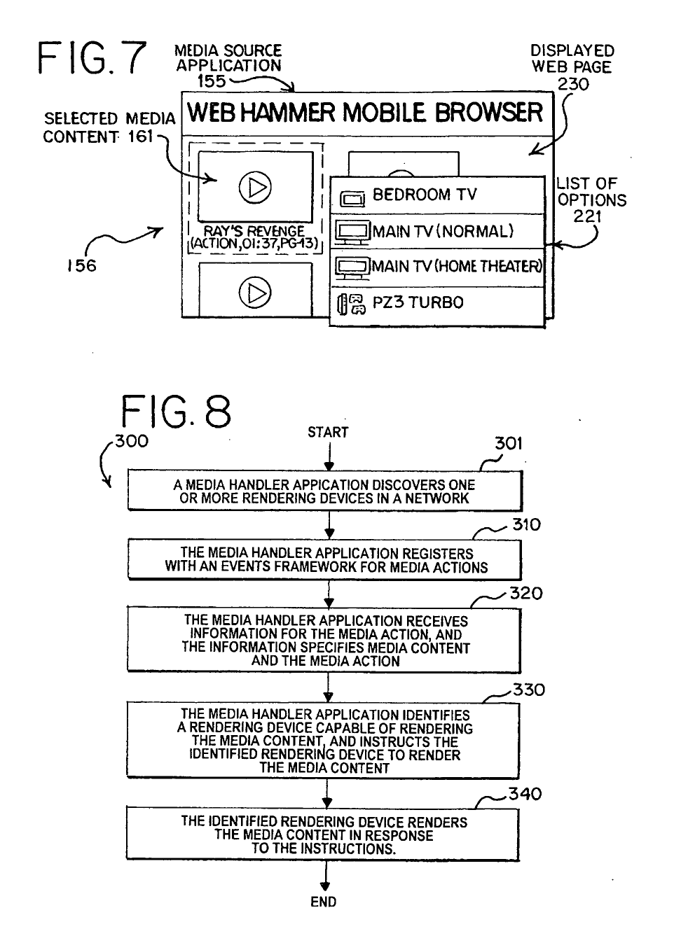

FIG. 5 generally illustrates an embodiment of a user interface 156 which may be presented by a media source application 155, such as, for example, one of the media source applications 111, 112, 113. The media source application 155 may enable the user 12 to access and/or use media content represented by representations 158, such as, for example, icons and/or text, in the user interface 156 of the media source application 155. In the example depicted in FIG. 5, the media source application 155 is a music application which may enable the user 12 to access and/or use music content, such as, for example, music tracks, music albums and/or playlists. In the example depicted in FIG. 5, the representations 158 presented in the user interface 156 represent a set of playlists available to the user 12.

The user 12 may identify selected media content 161 using the user interface 156 of the media source application 155. For example, the user 12 may select one of the representations 158 displayed by the user interface 156 to select one of the playlists. Further, the user interface 156 may provide a list of options 221 related to the selected media content 161. The options in the list of options 221 may be related to applications, services and/or handlers identified by the media source application 155 using the events framework 102 and/or the OS. Therefore, each of the options in the list of options 221 may be associated with an application, a service, and/or a handler registered with the events framework 102 and/or the OS for media actions related to the selected media content 161.

In the example depicted in FIG. 5, the list of options 221 related to the selected media content 161 may have options not associated with the media handler application 103. For example, the list of options 221 may have a first option to send the selected media content 161 using an email client and/or a second option to share the selected media content 161 using a social networking website, namely “FaceBank” as noted in FIG. 5. These options may or may not be available to the media source application 155 depending on whether the associated applications, services and/or handlers exist on the computing device 11.

The list of options 221 related to the selected media content 161 may have one or more options to render the selected media content 161 using the media handler application 103. In the example depicted in FIG. 5, the list of options 221 has an option to render the selected media content 161 using the media handler application 103, and the option is depicted as a third option 225, namely “RenderMate 5,” which may be the name of the media handler application 103 as provided by the media handler application 103 when registering with the events framework 102 and/or the OS. In addition, the third option 225 associated with the media handler application 103 may have the graphic symbol and/or icon provided by the media handler application 103 at registration. In the example depicted in FIG. 5, the graphic symbol and/or icon provided by the media handler application 103 at registration is an encircled “R” symbol.

A single option associated with the media handler application 103, such as the third option 225 in FIG. 5, may be appropriate if the media handler application 103 provides aggregate media capabilities which describe all of the media capabilities and/or the media types which the media handler application 103 may render using the available media rendering devices. As previously discussed, the aggregate capabilities may include all capabilities and/or all media types aggregated from all of the available media rendering devices identified by the media handler application 103, and the aggregate capabilities may be extended using the transcoding capabilities, if any, of the media handler application 103. Therefore, the presence of the third option 225 associated with the media handler application 103 in the list of options 221 may indicate to the user 12 that at least one of the available media rendering devices is capable of rendering the selected media content 161, namely the music content associated with the playlist selected by the user 12.

In an embodiment, selection of the third option 225 associated with the media handler application 103 in the user interface 156 of the media source application 155 may initiate rendering of the music content associated with the playlist on a default media rendering device previously configured by the user 12. The default media rendering device may be a default audio rendering device previously configured by the user 12. Alternatively, the selection of the third option 225 associated with the media handler application 103 may result in the user interface 121 of the media handler application 103 enabling the user 12 to choose among the available media rendering devices which are capable of rendering the selected music content 161.

FIG. 6 illustrates another embodiment of the user interface 156 which may be presented by a media source application 155. In the example depicted in FIG. 6, the media source application 155 is a photo browser which may enable the user 12 to access and/or use image content, such as, for example, digital photographs and/or photo albums. In the example depicted in FIG. 6, the media content presented in the user interface 156 represents a set of digital photographs and photo albums available to the user 12. In FIG. 6, a photo album has multiple associated digital photographs represented in the user interface 156 as multiple photographs overlaid at different angles.

The media source application 155 may enable the user 12 to select media content in the user interface 156 of the media source application. In the example depicted in FIG. 6, the selected media content 161 is a photo album. Further, the media source application 155 may present a list of options 221 related to the selected media content 161, namely the digital photographs included in the selected photo album. In the example depicted in FIG. 6, each option of the list of options 221 corresponds to a different media handler service associated with the media handler application 103. The listed options include a first option to render the selected media content 161 to a first photo frame located in the kitchen, a second option to render the selected media content 161 to a second photo frame located in the bedroom, a third option to render the selected media content 161 to a DLNA-compatible television located in the living room, a fourth option to render the selected media content 161 to a portable device, namely an “eTablet Device” as noted in FIG. 6, and a fifth option to render the selected media content 161 to a group of media rendering devices which includes all available photo devices.

In presenting the list of options 221 related to the selected media content 161, the media source application 155 may use the events framework 102 and/or the OS to identify applications, services and/or handlers capable of participating in a media action for the selected media content 161. The media source application 155, the events framework 102 and/or the OS may use the media type of the selected media content 161 and/or a description of the selected media content 161 to identify the applications, services and/or handlers capable of handling the selected media content 161. As a result, the media source application 155 may identify the media handler services previously registered by the media handler application 103 which are capable of handling the selected media content 161 as evidenced by the media capabilities and/or the media types provided by the media handler application 103 when registering each of the media handler services.

As previously discussed, the media capabilities and/or the media types provided when registering a media handler service may correspond to the media capabilities and/or the media types associated with the media rendering device represented by the media handler service. Therefore, the presence of the first option, the second option, the third option and the fourth option may indicate to the user that each of the associated media rendering devices, namely the photo frame in the kitchen, the photo frame in the bedroom, the DLNA-compatible television in the living room and the portable “eTablet” device, are capable of rendering the selected media content 161. Selection of one of the four options by the user 12 may result in the corresponding media handler service and/or the media handler application 103 participating in the media action. As a result, the media handler application 103 may render the selected media content 161 on the media rendering device associated with the selected option.

The fifth option displayed in FIG. 6 as an “all photo devices” option may enable the user 12 to transfer, to send, and/or to render the selected media content 161 using multiple image rendering devices simultaneously. The fifth option may correspond to a group of media rendering devices selected and/or configured by the user 12 using the user interface 121 of the media handler application 103. Alternatively, the fifth option may correspond to a group of media rendering devices created automatically by the media handler application 103. In either case, the media handler application 103 may create, may initiate, may have and/or may register a media handler service corresponding to the group of media rendering devices. In the example depicted in FIG. 6, the media handler service corresponding to the group of media rendering devices may correspond to all of the media rendering devices capable of rendering digital photographs.

When registering the media handler service corresponding to the fifth option, the media handler application 103 may have provided the text string “all photo devices” as the name of the media handler service and/or as the description of the media handler service. The text string “all photo devices” provided by the media handler application 103 may enable the media source application to display “all photo devices” when presenting the fifth option in the user interface 156 of the media source application 155. The media handler application 103 may have provided a graphic symbol and/or icon indicating multiple different photo devices to enable the media source application 155 to visually indicate that the fifth option enables the user 12 to render the selected media content 161 on multiple media rendering devices simultaneously.

When registering the handler service corresponding to the fifth option, the media handler application 103 may have provided the set of media capabilities common to all of the media rendering devices associated with the fifth option and/or the list of media types common to all of the media rendering devices associated with the fifth option. As a result, the media source application 155 may be able to determine that the selected media content 161 matches the media capabilities and/or the media types associated with the media handler service corresponding to the fifth option and/or may verify that all of the media rendering devices associated with the fifth option are capable of rendering the selected media content 161.

Selection of the fifth option by the user 12 may direct the corresponding media handler service and/or the media handler application 103 to participate in the corresponding media action. As a result, the media handler application 103 may render the selected media content on the media rendering devices associated with the fifth option.

FIG. 7 generally illustrates another embodiment of the user interface 156 which may be presented by a media source application 155. In the example depicted in FIG. 7, the media source application 155 is a mobile web browser which enables the user to browse, to select, to retrieve, to display, and to use webpages, such as the displayed webpage 230. The webpages may include, may contain and/or may reference media content. Thus, the media source application 155 may enable the user 12 to access, to view and/or to use media content in the displayed webpage 230 of the user interface 156 of the media source application 155.

The media source application 155 may allow the user 12 to identify selected media content 161 using the user interface 156 of the media source application 155. In FIG. 7, the selected media content 161 is a video file containing a movie. Furthermore, the media source application 155 may present the list of options 221 related to the selected media content 161, namely the video file containing the movie. In the example depicted in FIG. 7, the listed options include a first option to render the selected media content 161 on a television located in the bedroom, a second option to render the selected content 161 on a central television using a “Normal” profile, a third option to render the selected content 161 on the central television using a “Home Theater” profile, and a fourth option to render the selected content 161 on a gaming console, namely the “PZ3 Turbo” as noted in FIG. 7.

The first option and the fourth option are similar to several previously presented examples in that the first option and the fourth option each correspond to a media handler service which represents a single media rendering device. As in the previous examples, the media source application 155 may display the name, the text description, and/or the graphic symbol and/or icon provided for the media handler service at registration. As a result, the media source application may indicate and/or may describe the media rendering device used to render the selected media content 161 in response to selection of the first option or the fourth option by the user 12.

The second option and the third option illustrate the use of user-defined profiles as previously described. The user 12 may have previously configured a “Normal” profile and a “Home Theater” profile. For example, the user 12 may have previously configured these profiles using the user interface 121 of the media handler application 103. The user 12 may have configured the “Normal” profile to correspond to the central television using device settings defined by the user 12 for the “Normal” profile. In addition, the user 12 may have configured the “Home Theater” profile to correspond to the central television using different device settings defined by the user 12 for the “Home Theater” profile. As described previously, the “Normal” profile and the “Home Theater” profile may be configured by the user 12 to include device settings to control the central television and/or additional device settings to control devices other than the central television. For example, the profiles may be associated with home automation settings and/or with settings for media rendering devices other than the central television. As an example of settings for media rendering devices other than the central television, the “Home Theater” profile may be associated with a setting to turn the volume of a separate internet radio device to zero when rendering media content to the central television using the “Home Theater” profile.

The media handler application 103 may create, may instantiate, may have and/or may register media handler services corresponding to profiles, such as, for example, the “Normal” profile and/or the “Home Theater” profile. In addition, the media handler application 103 may store records associated with the user-defined profiles. For example, the application control component 125 of the media handler application 103 may store records which describe the settings associated with each of the user-defined profiles.

Registration of a media handler service associated with a profile may provide a handler service name and/or descriptive text for the media handler service which indicate the media rendering device and/or the profile associated with the media handler service. For example, including the text string “Main TV (Home Theater)” in the handler service name and/or description may enable the media source application 155 to indicate to the user 12 that the third option corresponds to the central television and the “Home Theater” profile. Registration may provide a graphic symbol and/or icon descriptive of the media rendering device and/or the profile. In the example depicted in FIG. 7, the graphic symbol associated with the third option indicates the central television.

Selection of the second option or the third option by the user 12 may result in the corresponding media handler service and/or the media handler application 103 participating in the corresponding media action. As a result, the media handler application 103 may render the selected media content on the media rendering devices associated with the second option or the third option. As a result, the media handler application 103 may render the selected media content 161 on the central television associated with the second option and the third option.

In addition, the media handler application 103 may communicate with the central television and/or other devices to modify the settings in accordance with the profile. For example, selection of the third option may cause the media handler application 103 to communicate with the central television, the home automation system and/or the Internet radio device to modify the settings in accordance with the “Home Theater” profile. The media handler application 103 may consult previously stored records associated with configuration of the profile to determine what settings must be modified on each device in accordance with the profile.

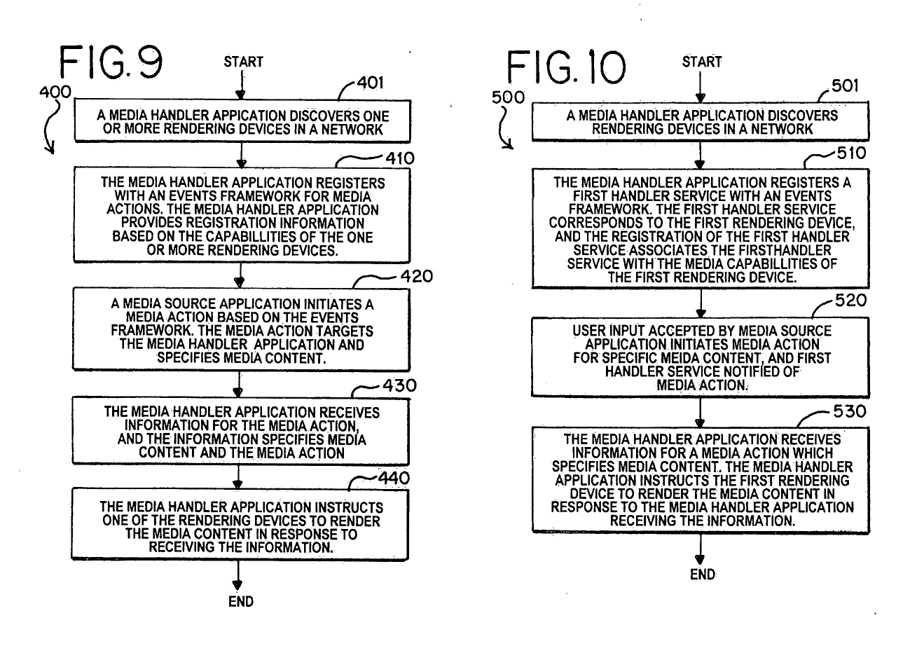

FIG. 8 generally illustrates a method 300 for transferring media content in an embodiment of the present invention. In step 301, the media handler application 103 may identify media rendering devices in the network 15. One or more of the media rendering devices may be UPnP AV-compliant rendering devices. In step 310, the media handler application 103 may register with the events framework 102 for media actions. The media handler application 103 may register with the events framework 102 in response to detection of a media rendering device in the network 15 and/or in response to the computing device 11 connecting to the network 15.

In an embodiment, the media source application 155 may present options related to the media content available in the media source application 155, and one of the options may correspond to the media handler application 103. The user 12 may select the option corresponding to the media handler application 103. Then, the media source application 155 may initiate a media action using the events framework 102, and the media action may target the media handler application 103 and/or may specify the media content. In step 320, the media handler application 103 may receive information for a media action which specifies media content and the media action.

In step 330, the media handler application 103 may identify one or more of the available media rendering devices as capable of rendering the media content and may direct the one or more of the available media rendering devices capable of rendering the media content to render the media content. In an embodiment, the media handler application 103 may identify the media rendering device as capable of rendering the media content based on capabilities of the media rendering device. In an embodiment, the media handler application 103 may identify the media rendering device as capable of rendering the media content based on one or more preferred rendering devices specified by the user 12 of the media handler application 103 before the media handler application 103 participates in the media action. In an embodiment, the media handler application 103 may display a list of media rendering devices capable of rendering the media content, and user input which selects one of the media rendering devices from the list may identify the media rendering device which renders the media content. In step 340, the one or more of the available media rendering devices capable of rendering the media content may render the media content in response to the communication from the application.

FIG. 9 generally illustrates a method 400 for transferring media content in an embodiment of the present invention. In step 401, the media handler application 103 may identify media rendering devices in the network 15. In step 410, the media handler application 103 may register with the events framework 102 for media actions and/or may provide registration information based on the capabilities of the media rendering devices in the network 15. The registration information may describe an aggregate set of media capabilities for the available media rendering devices. In an embodiment, the media source application 155 may present options related to media content available in the media source application 155, and one or more of the options may be based on the registration information. The user 12 may select one of the options. In step 420, the media source application 155 may initiate a media action for specific media content based on the events framework 102, and/or the media action may target the media handler application 103.

In step 430, the media handler application 103 may receive information for a media action which specifies media content and the media action. In an embodiment, the method 400 may have an additional step of identifying which available media rendering devices are capable of rendering the specific media content, and the media handler application 103 may identify the capable media rendering devices based on the capabilities of the available media rendering devices. In step 440, the media handler application 103 may direct one or more of the available media rendering devices capable of rendering the media content to render the media content. In an embodiment, the media handler application 103 may communicate with the target rendering device using a protocol based on the UPnP AV standard. In an embodiment, the media content may be located on a remote server accessible using the internet, and/or the media handler application 103 may provide the media content to the target rendering device by transmitting a URL which specifies the location of the media content. In an embodiment, the media handler application 103 may make the media content available to the target rendering device using the media server component 123 of the media handler application 103.

In an embodiment, the method 400 may have an additional step of the media handler application 103 modifying the media content for compatibility with the media capabilities of one of the media rendering devices. The target rendering device may render the media content in response to communication from the media handler application 103.

FIG. 10 generally illustrates a method 500 for transferring media content in an embodiment of the present invention. In step 501, the media handler application 103 may identify media rendering devices in the network 15. In step 510, the media handler application 103 may register the first handler service 151 corresponding to the first rendering device 31 of the media rendering devices in the network 15, and/or the media handler application 103 may register the first handler service 151 with the events framework 102. In an embodiment, the method 500 may have an additional step of the media handler application 103 providing registration information when registering the first handler service 151, and/or the registration information may include a text string and/or a graphic image descriptive of the first rendering device.

In an embodiment, the media source application 155 may provide options to the user 12 of the media source application 155. The options may relate to the media content and/or may include an option associated with the first handler service. User input in the media source application 155 may select one of the options.

In an embodiment, the media handler application 103 may register a second handler service 152 with the events framework 102, and/or the second handler service 152 may correspond to the second rendering device 32 of the media rendering devices in the network 15. The media source application 155 may provide options to the user 12 of the media source application 155. The options may relate to the media content and/or may include a first option associated with the first handler service 151 and/or a second option associated with the second handler service 152. User input in the media source application 155 may select one of the options.

In step 520, user input accepted by the media source application 155 initiates a media action for specific media content, and/or the first handler service 151 may be notified of the media action. In step 530, the media handler application 103 may receive information for a media action which specifies media content, and/or the media handler application 103 may direct the first media rendering device 31 to render the media content. The first media rendering device 31 may render the media content.

In an embodiment, the media handler application 103 may register a second handler service 152 with the events framework 103, and/or the second handler service 152 may correspond to a group of media rendering devices. The registration of the second handler service 152 may associate the second handler service 152 with media capabilities common to the group of media rendering devices. The second handler service 152 may participate in a media action based on input from the user 12, and/or the media action may identify specific media content. The media handler application 103 may receive information based on the media action, and/or the media handler application 103 may instruct the group of media rendering devices to render the media content in response to the media handler application 103 receiving the information based on the media action. The group of media rendering devices may render the media content simultaneously.

In an embodiment, the method 500 may have an additional step of defining a profile associated with one of the media rendering devices. The profile may include a setting specified by the user 12 of the media handler application 103, and/or the setting may be associated with a device and/or one of the handler services. The setting may have a setting name, a setting identifier and/or a value. The device may receive instructions which may specify the setting name, the setting identifier and/or the parameter value. The device may be one of the media rendering devices and/or a home automation control device.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A method for transferring media content using a media handler application executed by a general purpose computing device connected to a network, the method comprising the steps of:
identifying one or more rendering devices in the network wherein the media handler application identifies the one or more rendering devices in the network;
registering with an events framework wherein the media handler application registers for media actions with the events framework;
receiving information on the media handler application wherein the information specifies a first media action of the media actions and further wherein the information specifies identified media content;
identifying a target rendering device of the one or more rendering devices in the network wherein the target rendering device is capable of rendering the identified media content and further wherein the media handler application identifies the target rendering device;
transmitting a communication from the media handler application to the target rendering device wherein the communication instructs the target rendering device to render the identified media content; and
rendering the identified media content on the target rendering device in response to the target rendering device receiving the communication.

2. The method of claim 1 further comprising the steps of:
displaying options in a user interface of a media source application executed by the general purpose computing device wherein the options are displayed after the media handler application registers with the events framework and further wherein the options are related to media content available in the media source application wherein one of the options corresponds to the media handler application and further wherein the media source application is a different application than the media handler application;
accepting user input on the general purpose computing device which selects the one of the options corresponding to the media handler application; and
generating the information which specifies the first media action and the identified media content wherein the media source application generates the information in response to the user input selecting the one of the options corresponding to the media handler application.

3. The method of claim 1 wherein the one or more rendering devices in the network are UPnP AV-compliant rendering devices.

4. The method of claim 1 wherein the media handler application identifies the target rendering device based on capabilities of the target rendering device.

5. The method of claim 1 wherein the media handler application identifies the target rendering device based on one or more preferred rendering devices specified by a user of the media handler application before the media handler application received the information which specifies the first media action and the identified media content.

6. The method of claim 1 further comprising the steps of:
displaying a list of rendering devices capable of rendering the identified media content wherein the media handler application displays the list after receiving the information which specifies the first media action and the identified media content; and
accepting user input on the general computing device which selects the target rendering device from the list wherein the communication is transmitted to the target rendering device in response to the user input.

7. The method of claim 1 wherein the media handler application registers with the events framework in response to detection of one of the one or more rendering devices in the network.

8. The method of claim 1 wherein the media handler application registers with the events framework in response to the general purpose computing device connecting to the network.

9. A method for transferring media content using a media handler application executed by a general purpose computing device connected to a network, the method comprising the steps of:
identifying one or more rendering devices in the network wherein the media handler application identifies the one or more rendering devices in the network;
registering with an events framework wherein the media handler application registers for media actions with the events framework and further wherein the media handler application provides registration information based on media capabilities of the one or more rendering devices;
generating information which specifies a first media action of the media actions wherein the information specifies the media content wherein a media source application executed by the general purpose computing device generates the information and further wherein the media source application is a different application than the media handler application;
receiving the information wherein the media handler application receives the information; and
transmitting a communication to one of the one or more rendering devices wherein the communication instructs the one of the one or more rendering devices to render the media content and further wherein the media handler application transmits the communication in response to receiving the information which specifies the first media action and the media content.

10. The method of claim 9 further comprising the steps of:
displaying options related to media content available in the media source application wherein the options are displayed by a user interface provided by the media source application and further wherein one or more of the options are based on the registration information; and
accepting user input which identifies a selected option of the options wherein the selected option is one of the one or more options based on the registration information and further wherein the media source application generates the information in response to the user input.

11. The method of claim 9 wherein the communication uses a protocol based on the UPnP AV standard.

12. The method of claim 9 wherein the registration information describes an aggregate set of media capabilities for the one or more rendering devices.

13. The method of claim 9 further comprising the step of:
identifying a capable rendering device of the one or more rendering devices wherein the capable rendering device is capable of rendering the media content and further wherein the media handler application identifies the capable rendering device based on the capabilities of the one or more rendering devices.

14. The method of claim 9 further comprising the step of:
modifying the media content for compatibility with the media capabilities of the one of the one or more rendering devices wherein the media handler application modifies the media content.

15. The method of claim 9 wherein the media content is located on a remote server accessible using the internet and further wherein the communication sent from the media handler application to the one of the one or more rendering devices includes a URL which specifies the location of the media content.

16. The method of claim 9 wherein the media handler application has a server component which provides access to the media content for the one of the one or more rendering devices which receives the communication.

17. A method for transferring media content using a media handler application executed by a general purpose computing device connected to a network, the method comprising the steps of:
identifying one or more rendering devices in the network wherein the media handler application identifies the one or more rendering devices in the network;
registering a first handler service with an events framework wherein the media handler application registers the first handler service for media actions with the events framework and further wherein the first handler service corresponds to a first rendering device of the one or more rendering devices and further wherein registration of the first handler service associates the first handler service with media capabilities of the first rendering device;
generating first information which specifies first media content wherein a media source application generates the first information based on first user input in the media source application and further wherein the media source application is a different application than the media handler application;
receiving the first information wherein the first handler service receives the first information based on the registration of the first handler service with the events framework; and
directing the first rendering device to render the first media content in response to the first handler service receiving the first information.

18. The method of claim 17 further comprising the step of:
providing registration information which includes a text string descriptive of the first rendering device wherein the media handler application provides the registration information when registering the first handler service.

19. The method of claim 17 further comprising the step of:
providing registration information which includes a graphic image descriptive of the first rendering device wherein the media handler application provides the registration information when registering the first handler service.

20. The method of claim 17 further comprising the steps of:
displaying options in a user interface provided by the media source application wherein the options relate to the first media content and include a first option associated with the first handler service;
accepting second user input wherein the second user input selects the first option; and
transmitting the first information wherein the media source application transmits the first information in response to the second user input.

21. The method of claim 17 further comprising the step of:
registering a second handler service with the events framework wherein the second handler service corresponds to a second rendering device and further wherein the media handler application registers the second handler service.

22. The method of claim 17 further comprising the step of:
registering a second handler service with the events framework wherein the second handler service corresponds to a group of rendering devices which includes the first rendering device and a second rendering device and further wherein the media handler application registers the second handler service.

23. The method of claim 21 further comprising the step of:
associating the second handler service with media capabilities common to both the first rendering device and the second rendering device wherein the registration of the second handler service associates the second handler service with the media capabilities.

24. The method of claim 21 further comprising the steps of:
generating second information which specifies second media content wherein the media source application generates the second information based on second user input in the media source application;
displaying options in the media source application wherein the options relate to the second media content and further wherein the options include a first option associated with the first handler service and a second option associated with the second handler service;
accepting third user input in the media source application wherein the third user input selects the second option;
transmitting the second information wherein the media source application transmits the second information in response to the third user input;
receiving the second information wherein the second handler service receives the second information based on the registration of the second handler service with the events framework; and
directing the first rendering device and the second rendering device to render the second media content in response to the second handler service receiving the second information.

25. The method of claim 17 further comprising the steps of:
defining a profile associated with the first rendering device wherein the profile includes a setting specified by a user of the media handler application and further wherein the setting is associated with a device wherein the setting has a setting identifier and a value and further wherein the first handler service is associated with the profile; and
sending instructions to the device wherein the instructions specify the setting identifier and the value.

26. The method of claim 24 wherein the device is the first rendering device.

27. The method of claim 24 wherein the device is one of the one or more rendering devices in the network other than the first rendering device.

28. The method of claim 24 wherein the device is a home automation control device.

29. A system for transferring media content, the system comprising:
a media handler application executed by a general purpose computing device connected to a network wherein the media handler application identifies one or more rendering devices in the network;
a first handler service connected to the media handler application wherein the first handler service corresponds to one or more first rendering devices of the one or more rendering devices in the network;
a first registration with an events framework wherein the first registration associates the first handler service with media capabilities of the one or more first rendering devices;
a second handler service connected to the media handler application wherein the second handler service corresponds to one or more second rendering devices of the one or more rendering devices in the network;
a second registration with the events framework wherein the second registration associates the second handler service with media capabilities of the one or more second rendering devices;
information received by one of the first handler service and the second handler service wherein the information identifies the media content; and
communications transmitted to one or more third rendering devices wherein the communications direct the one or more third rendering devices to render the media content wherein the third rendering devices are the first rendering devices if the information was received by the first handler service wherein the third rendering devices are the second rendering devices if the information was received by the second handler service.

30. The system of claim 29 wherein the one or more first rendering devices associated with the first handler service are specified by a user of the media handler application before the media handler application registers the first handler service with the events framework.

31. The system of claim 29 wherein the media handler application removes the first registration from the events framework in response to unavailability of the one or more first rendering devices.

32. The system of claim 29 wherein the first registration associates the first handler service with media capabilities which are common to all of the one or more first rendering devices.

33. The system of claim 29 wherein the media handler application selects the one or more first rendering devices for association to the first handler service wherein the media handler application selects the one or more first rendering devices from among the one or more rendering devices in the network without user input specifying the one or more first rendering devices.

34. The system of claim 29 wherein the media handler application registers the first handler service with the events framework to produce the first registration and further wherein the media handler application registers the second handler service with the events framework to produce the second registration.

35. The system of claim 29 wherein the media handler application transmits the communications to the one or more third rendering devices.

36. The method of claim 29 wherein at least one of the communications is based on the UPnP AV standard.

37. The system of claim 29 further comprising:
a media source application executed by the general purpose computing device wherein the media content is available in the media source application wherein the media source application is a different application than the media handler application and further wherein the media source application receives information about the first registration and the second registration from the events framework; and
a user interface associated with the media source application wherein the user interface displays options which relate to the media content and further wherein the options include a first option associated with the first handler service and a second option associated with the second handler service.

38. The system of claim 35 further comprising:
user input accepted by the user interface wherein the user input selects one of the first option and the second option wherein the media source application transmits the information to the first handler service if the user input selects the first option and further wherein the media source application transmits the information to the second handler service if the user input selects the second option.
